(19) United States
(12) Patent Application Publication
(10) Pub. No.: US 2006/0245873 A1
(43) Pub. Date: Nov. 2, 2006

(54) Snowmobile lifting device

(76) Inventor: Jim D. Black, Powell, WY (US)

Correspondence Address: Antoinett M. Tease, P.L.L.C., PO Box 51016, Billings, MT, 59105, US

(21) Appl. No.: 11/095,850

(22) Filed: Mar. 31, 2005

(51) Int. Cl. B60P 3/00

(52) U.S. Cl. 414/458

(57) ABSTRACT

A snowmobile lifting device comprising a cross-bar, two wheel support members, two first legs, two second legs, a first lateral member, a second lateral member, a third lateral member, two cradle arms, and a handle. Each end of the cross-bar is attached to a wheel support member, each of the two first legs is connected at one end to a wheel support member and at the other end to the third lateral member, each of the two second legs is connected at one end to the cross-bar and at the other end to the third lateral member, the first lateral member joins the two first legs, the second lateral member joins the two second legs, the two second legs pivot inward or outward proximate to the point at which the second lateral member joins the two second legs, and the handle is pivotally attached to the center of the cross-bar.

### BACKGROUND OF THE INVENTION

1. Field of the Invention

The present invention relates to the field of lifting, moving and storage devices, and more specifically, to a device designed to lift, move and/or store a snowmobile. The device can also be readily adapted to fit all-terrain vehicles and other similar vehicles.

2. Description of the Related Art

The most typical current method of moving a snowmobile in a shop or garage is to lift the snowmobile, place three small platforms with wheels underneath the snowmobile's skis and tracks, and then pull the snowmobile wherever you want it to go. This method is clumsy, it requires enough strength to lift the entire snowmobile, it places most of the stress and strain of the lift on the user's back, and the platforms are not securely attached underneath the skis and tracks and can slip out. A number of snowmobile lifts have been devised, but many of them do not have wheels and do not allow for mobility. If they do have wheels, the lifts do not accommodate a wide range of snowmobiles, they are not adjustable, and they do not provide for flexibility in traveling over uneven areas or inclines in the surface over which the snowmobile is being pulled or pushed. The prior art wheeled devices still require a lot of strength from the user because they are not designed to transfer the weight of the snowmobile from the user to the lifting device.

U.S. Pat. No. 4,643,396 (Beals, 1987) discloses a stand for a motorized snow vehicle or the like. The stand does not have wheels, is not mobile, and does not allow the user to push or pull the snowmobile. This stand is designed strictly for cleaning, inspection or alignment of the snowmobile tracks.

U.S. Pat. No. 6,045,123 (Christen, 2000) provides a lifting apparatus that engages and lifts only the rear end of the snowmobile. The lifting device does not include wheels and does not allow the user to push or pull the snowmobile.

U.S. Pat. No. 5,145,154 (Bastille et al., 1992) involves a lift device for lifting the front or rear of a snowmobile, but the lift device is dependent on a power assist ram that actually does the heavy lifting.

U.S. Pat. No. 5,143,352 (Latimer, 1992) discloses a snowmobile lift apparatus that is immobile. This lift device is designed to lift the snowmobile drive surface during a warmup procedure of a snowmobile.

U.S. Pat. No. 5,716,061 (Sloan et al., 1998) provides a dolly for moving a snowmobile. The dolly includes a hydraulic jack with an elongated power ram and is designed primarily for use on the front end of the snowmobile.

U.S. Pat. No. 5,441,378 (Puls, 1995) involves another snowmobile dolly designed for use on the front end of the snowmobile only. This dolly was designed to accommodate various makes and models of snowmobiles, but this dolly is not interchangeable in that it cannot be used on the rear end of the vehicle.

U.S. Pat. No. 3,964,729 (Harlow) is another elevating device for snowmobiles. This device is immobile and designed primarily to lift the rear of the vehicle so that the drive tracks are off the ground. This device uses a rather simplistic pulley system that still requires the user to exert a fair amount of strength.

U.S. patent application Ser. No. 09/968,484 (Gargaro, filed Sep. 29, 2001) describes an oversized dolly that can be used for lifting and moving snowmobiles. The dolly is more than six feet tall, has two wheels, and is maneuvered so that the wheels roll on either side of the snowmobile.

U.S. patent application Ser. No. 10/368,052 (Leitner, filed Feb. 19, 2003) discloses a snowmobile stand mechanism that lifts only the drive track end (rear) of the snowmobile to avoid freezing of the drive track to the slide rails and to allow the drive train to be warmed up prior to movement of the vehicle.

Given the shortcomings of the prior art devices, it is an object of the present invention to provide a mobile snowmobile lifting device that can be used interchangeably on the front and rear ends of the vehicle, that can be adjusted to accommodate a wide range of snowmobile sizes, and that provides enough flexibility in its design to permit the vehicle to be pulled or pushed over uneven surfaces. It is a further object of the present invention to provide a device that is operated manually (without power) and yet can be operated easily by individuals of varying strengths without causing undue strain on the user. It is a further object of the present invention to provide a lifting device that can be used with all-terrain vehicles and the like.

### BRIEF SUMMARY OF THE INVENTION

The present invention is a snowmobile lifting device comprising a cross-bar, two wheel support members, two first legs, two second legs, a first lateral member, a second lateral member, a third lateral member, two cradle arms, and a handle, wherein each end of the cross-bar is attached to a wheel support member, wherein each of the two first legs is connected at one end to a wheel support member and at the other end to the third lateral member, wherein each of the two second legs is connected at one end to the cross-bar and at the other end to the third lateral member, wherein the first lateral member joins the two first legs, wherein the second lateral member joins the two second legs, wherein the two second legs pivot inward or outward proximate to the point at which the second lateral member joins the two second legs, and wherein the handle is pivotally attached to the center of the cross-bar. The two cradle arms are positioned at the top of each of the two second legs. More specifically, the top of the second legs are hollow, and the cradle arms comprise a bottom portion that fits inside the top of the second legs.

The cross-bar is preferably attached to the two wheel support members by a plurality of spring bolts. The device further comprises four caster wheels, two of which are attached to the bottom of each of the wheel support members. Optionally, at least two of the wheels comprise manual brakes.

One end of each of the two first legs is pivotally attached to one of the wheel support members, and the two first legs swivel at the point at which they attach to the wheel support members. The other end of each of the two first legs is pivotally attached to the third lateral member. One end of each of the two second legs is pivotally attached to the cross-bar, and the two second legs swivel at the point at which they attach to the cross-bar. The length of the first and/or second legs is optionally adjustable.

The handle also swivels at the point at which it attaches to the cross-bar, and the present invention optionally includes a cord that prevents the handle from falling to the ground when it is not locked to the second lateral member. The handle is optionally curved outward at its center and/or optionally modular to allow its length and/or shape to be adjusted.

The width of the entire lifting device can be increased or decreased by adjusting the lengths of the cross-member and the first, second and third lateral members. Furthermore, the point at which the cross-bar attached to each wheel support member is also optionally adjustable, as is the point at which each of the two first legs attaches to the wheel support member.

The present invention includes optional cradle arm extenders, cradle arm adjustment members, and a cradle mechanism that maintains the floor of the cradle arm parallel with the ground. The cradle mechanism comprises a first connecting arm and a second connecting arm, the first connecting arm is pivotally attached at one end to the cradle arm and pivotally attached at the other end to one end of the second connecting arm, and the second connecting arm is pivotally attached at its other end to the second lateral member.

The present invention includes a means for releasably locking the handle to the second lateral member. In one embodiment, the second lateral member comprises a first extension and a second extension, and the means for releasably locking the handle to the second lateral member comprises a pin that is inserted through a hole in the second extension and passes across the front of the handle and through another hole in the second extension on the other side of the handle.

The present invention includes a means for releasably locking the top half of one of the second legs to the first lateral member. In one embodiment, the first lateral member comprises an extension, and the means for releasably locking the top half of one of the second legs to the first lateral member comprises a pin that is inserted through a hole in the extension and a hole in the top half of the second leg.

The present invention optionally includes a means for releasably locking the handle to the second lateral member and a means for releasably locking the top half of one of the second legs to the first lateral member, wherein the means for releasably locking the handle to the second lateral member and the means for releasably locking the top half of one of the second legs to the first lateral member comprises an automatic locking system, wherein the automatic locking system comprises a lever, a spring bolt that connects one end of the lever to a first connecting bar, a peg that is attached to the other end of the first connecting bar, and a connecting plate, wherein the second lateral member comprises a first extension and a second extension, wherein the connecting plate is attached to the second extension, wherein the connecting plate comprises a first hole and a second hole, and wherein when the spring bolt is compressed, the peg can be moved from a first position in which it is inserted into the first hole in the connecting plate to a second position in which it is inserted into the second hole in the connecting plate.

The automatic locking system further comprises a second connecting bar, a third connecting bar, and a guide box, wherein the second connecting bar is attached to the lever and pivotally attached to the connecting plate and pivotally attached to the third connecting bar, wherein the third connecting bar is pivotally attached to a first rod, wherein the guide box is attached to the second extension, and wherein the first rod passes through the guide box and through holes in the second extension when the peg is inserted into the second hole in the connecting plate. The automatic locking system further comprises an upper housing and a lower housing, wherein the first lateral member comprises an extension, wherein the second connecting bar is pivotally attached to an L-shaped flange, wherein the L-shaped flange is pivotally attached to a fourth connecting bar, wherein the fourth connecting bar is attached at its other end to a second rod, and wherein the second rod passes through holes in the upper housing, the extension of the first lateral member and the top half of one of the second legs when the peg is inserted into the first hole in the connecting plate.

### BRIEF DESCRIPTION OF THE DRAWINGS

FIG. 1 is a perspective view of the lifting device of the present invention on the front and back end of a snowmobile.

FIG. 2 is a rear perspective view of the lifting device of the present invention with the handle in an upright position.

FIG. 3 is a rear perspective view of the lifting device of the present invention with the handle in an engage/disengage position.

FIG. 4 is a rear perspective view of the lifting device of the present invention with the handle in a pulling position.

FIG. 5 is a front view of the lifting device of the present invention with the handle in an upright position.

FIG. 6 is a front view of the lifting device of the present invention with the handle in an engage/disengage position.

FIG. 7 is a front view of the lifting device of the present invention with the handle in a pulling position.

FIG. 8 is a side view of the lifting device of the present invention with the handle in an upright position.

FIG. 9 is a side view of the lifting device of the present invention with the handle in an engage/disengage position.

FIG. 10 is a side view of the lifting device of the present invention with the handle in a pulling position.

FIG. 11 is a side view of the present invention (as in FIG. 10) with an exploded view of the handle.

FIG. 12 is a perspective view of the spring bolts that attach the first cross-member to the side rails.

FIG. 13 is a rear view of the lifting device of the present invention with the handle in an upright position.

FIG. 14 is a rear view of the lifting device of the present invention with the handle in an engage/disengage position.

FIG. 15 is a rear view of the lifting device of the present invention with the handle in a pulling position.

FIG. 16 is a top view of the lifting device of the present invention with the handle in an upright position.

FIG. 17 is a top view of the lifting device of the present invention with the handle in an engage/disengage position.

FIG. 18 is a top view of the lifting device of the present invention with the handle in a pulling position.

FIG. 19 is a bottom view of the lifting device of the present invention with the handle in an upright position.

FIG. 20 is a bottom view of the lifting device of the present invention with the handle in an engage/disengage position.

FIG. 21 is a bottom view of the lifting device of the present invention with the handle in a pulling position.

FIG. 21A is a front perspective view of the lifting device of the present invention showing the manual brakes on the two front wheels.

FIG. 21B is a partial perspective view of one of the front wheels showing the manual brake.

FIG. 22 is a perspective view of a cradle arm extender.

FIG. 22A is a perspective view of a cradle arm separate from the lifting device.

FIG. 23 is a front perspective view of the lifting device of the present invention with the cradle extensions.

FIG. 24 is a perspective view of the lifting device of the present invention on the rear of the snowmobile with the cradle extensions.

FIG. 25 is a perspective view of a first cradle adjustment member.

FIG. 26 is a rear perspective view of the lifting device of the present invention with the first cradle adjustment members in a first orientation.

FIG. 27 is a perspective view of a second cradle adjustment member.

FIG. 28 is a rear perspective view of the lifting device of the present invention with the second cradle adjustment members in a first orientation.

FIG. 29 is a side view of the lifting device of the present invention with an alternate cradle mechanism that maintains the floor of the cradle parallel with the ground. In this figure, the handle is in an upright position.

FIG. 30 is a side view of the lifting device of the present invention with an alternate cradle mechanism that maintains the floor of the cradle parallel with the ground. In this figure, the handle is in an engage/disengage position.

FIG. 31 is a front perspective view of the manual locking system of the present invention with the handle locked onto the second lateral member.

FIG. 32 is a front perspective view of the manual locking system of the present invention with the first lateral member locked onto the top half of one of the second legs.

FIG. 33 is a front perspective view of the automatic locking system of the present invention with the handle locked onto the second lateral member.

FIG. 34 is a front perspective view of the automatic locking system of the present invention with the first lateral member locked onto the top half of one of the second legs.

FIG. 35 is a rear perspective view of the automatic locking system of the present invention with the handle locked onto the second lateral member.

FIG. 36 is a rear perspective view of the automatic locking system of the present invention with the first lateral member locked onto the top half of one of the second legs.

FIG. 37 is a side perspective view of the automatic locking system of the present invention separate from the lifting device. In this figure, the locking system is in the position it would be in if the handle were locked onto the second lateral member (i.e., the engage/disengage position).

FIG. 38 is a side perspective view of the automatic locking system of the present invention separate from the lifting device. In this figure, the locking system is in the position it would be in if the device were locked for storage (i.e., with the top half of one of the second legs locked onto the first lateral member).

### REFERENCE NUMBERS

1 Cross-bar
2 Wheel support member
3 First leg
4 Second leg
5 First lateral member
6 Second lateral member
7 Third lateral member
8 Cradle arm
9 Handle
10 Spring bolt
11 Caster wheel
12 Pivot point (in middle of second leg)
13 Cord
14 Aperture
15 Bolt
16 Manual brake
17 Pin
18 Extension of first lateral member
19 First extension of second lateral member
20 Second extension of second lateral member
21 Cradle arm extender
22 Top portion of cradle arm extender
23 Bottom portion of cradle arm extender
24 Top portion of the cradle arm
25 Bottom portion of the cradle arm
26 First cradle arm adjustment member
27 First tube of first cradle arm adjustment member
28 Second tube of first cradle arm adjustment member
28a Bridge of first cradle arm adjustment member
29 Second cradle arm adjustment member
30 First tube of second cradle arm adjustment member
31 Second tube of second cradle arm adjustment member
31a Bridge of second cradle arm adjustment member
32 Cradle arm floor
33 First connecting arm
34 Second connecting arm
35 Lever
36 First connecting bar
37 Peg
38 Connecting plate
39 Second connecting bar
39a L-shaped flange
40 Third connecting bar
41 First rod
42 Guide box
43 Fourth connecting bar
44 Second rod
45 Spring clip
46 Upper housing
47 Lower housing
48 Snowmobile railing

### DETAILED DESCRIPTION OF INVENTION

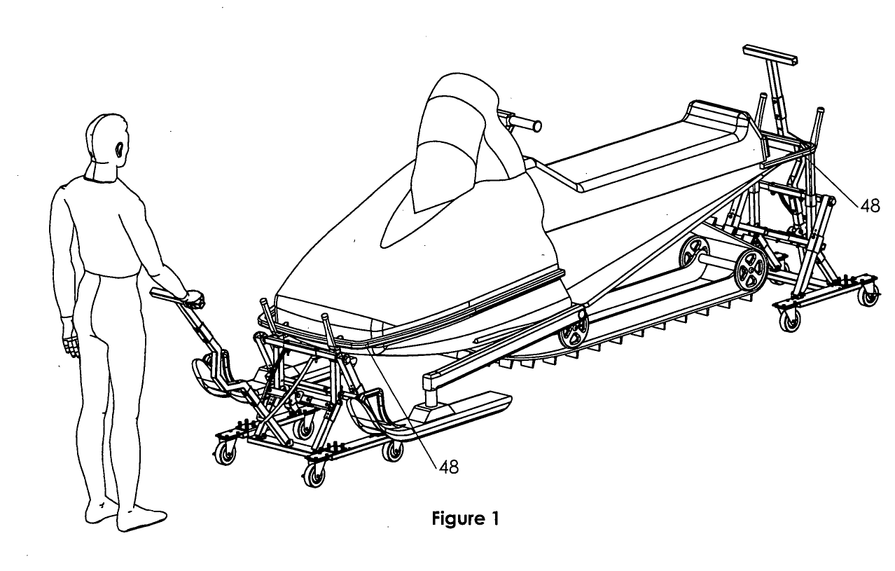

FIG. 1 is a perspective view of the lifting device of the present invention on the front and back end of a snowmobile. This figure illustrates the versatility of the present invention in that it can be used on the front and/or back end of the vehicle. The features of the present invention that make that versatility possible are illustrated in detail in the following figures.

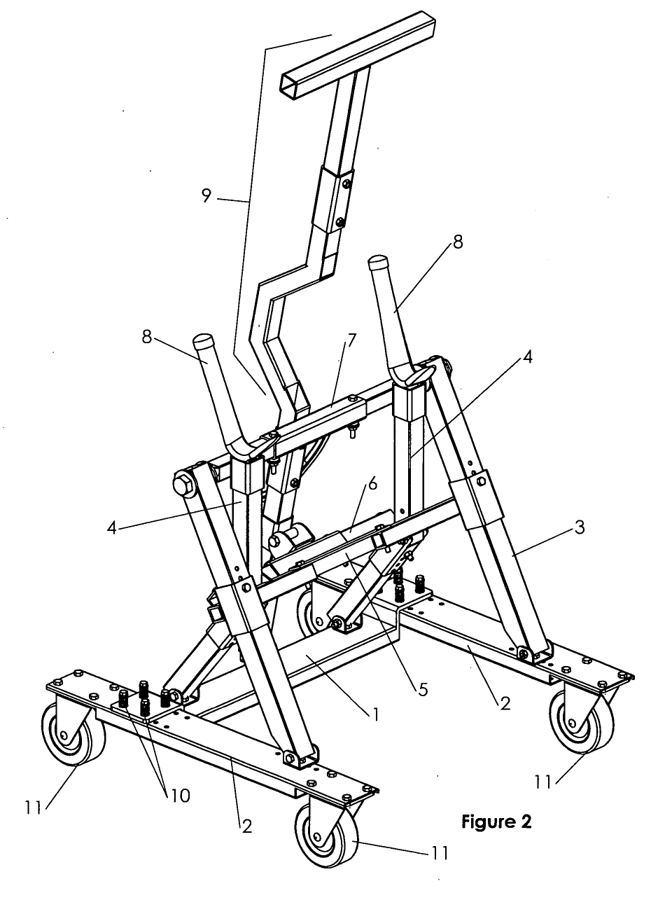

FIG. 2 is a front perspective view of the lifting device of the present invention with the handle 9 in an upright position. This figure illustrates the main components of the present invention, which are the cross-bar 1, two wheel support members 2, two first legs, two second legs 4, a first lateral member 5, a second lateral member 6, a third lateral member 7, two cradle arms 8, and a handle 9. In the preferred embodiment, the cross-bar 1 is attached to the two wheel support members 2 by a plurality of spring bolts that provide flexibility to the unit. Underneath each wheel support member 2 are two caster wheels 11. One end of each of the two first legs 3 is pivotally attached to one of the wheel support members 2 at the end furthest from the cross-bar 1. The first legs 3 also swivel (i.e., from side to side) at this attachment point. The other end of each of the two first legs 3 is pivotally attached to one end of the third lateral member 7. A first lateral member 5 is non-pivotally attached at each end to the first legs 3.

The first legs 3 are rigid and do not move other than at their attachment points to the wheel support members 2 and the third lateral member 7. The second legs 4, on the other hand, have a pivot point (shown more clearly in subsequent figures) in the middle of the leg, as well as on the cross-bar 1, where they also swivel. The second legs 4 are also attached to the third lateral member 7, but they do not pivot at that attachment point. A second lateral member 6 is non-pivotally attached at each end to the second legs 4 proximate to the pivot point in the middle of each second leg 4.

The tops of the second legs 4 serve as receivers for the cradle arms 8, which are free to rotate to accommodate different shapes of snowmobile rails 48. The bottom of the handle 9 is pivotally attached to the cross-bar. This pivot point is better shown in subsequent drawings.

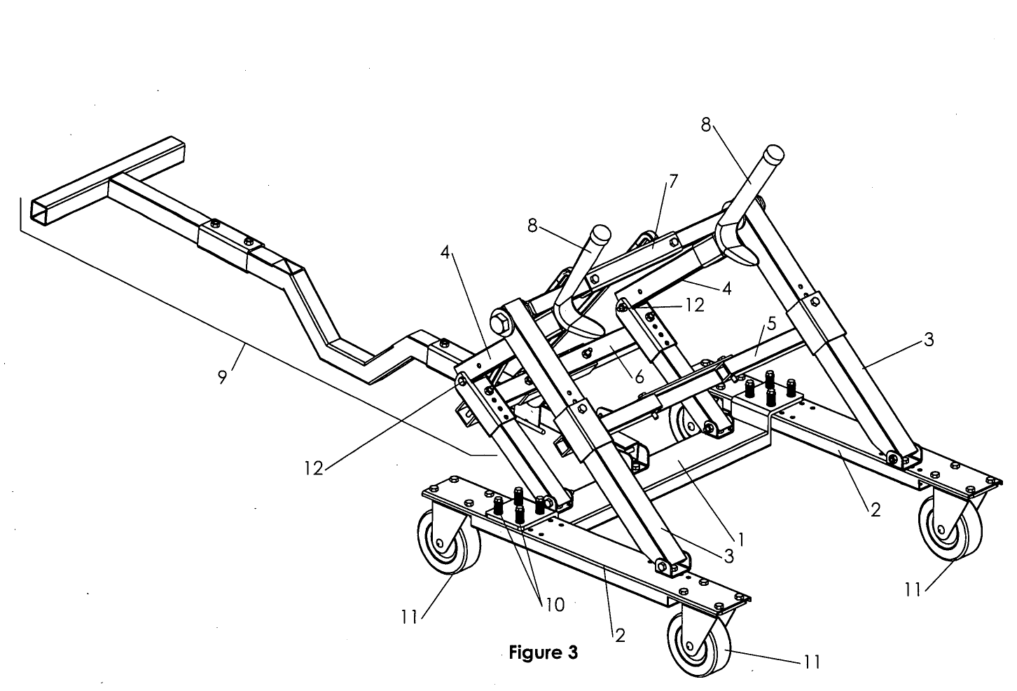

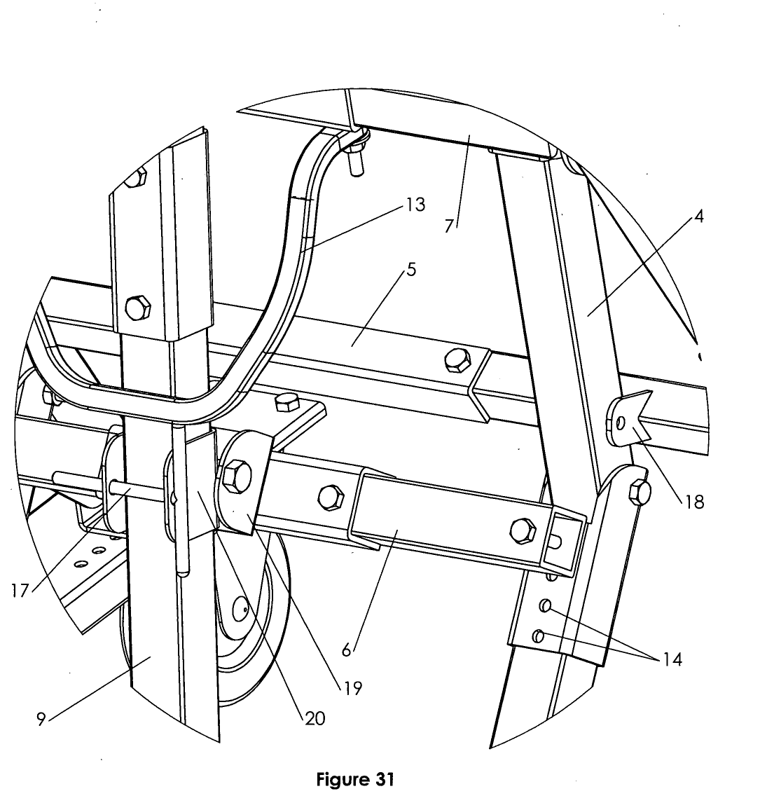

FIG. 3 is a front perspective view of the lifting device of the present invention in which the handle 9 is locked to the second lateral member 6 (see FIG. 31). This is the position the lifting device would be in to either disengage the lifting device from the snowmobile or to engage and lift the snowmobile off the ground. Hereinafter, this position will be referred to as the “engage/disengage” position. This figure shows more clearly the pivot point 12 in the middle of each second leg 4. This pivot point is key to the operation of the present invention because it effectuates the transfer of weight from the snowmobile to the lifting device.

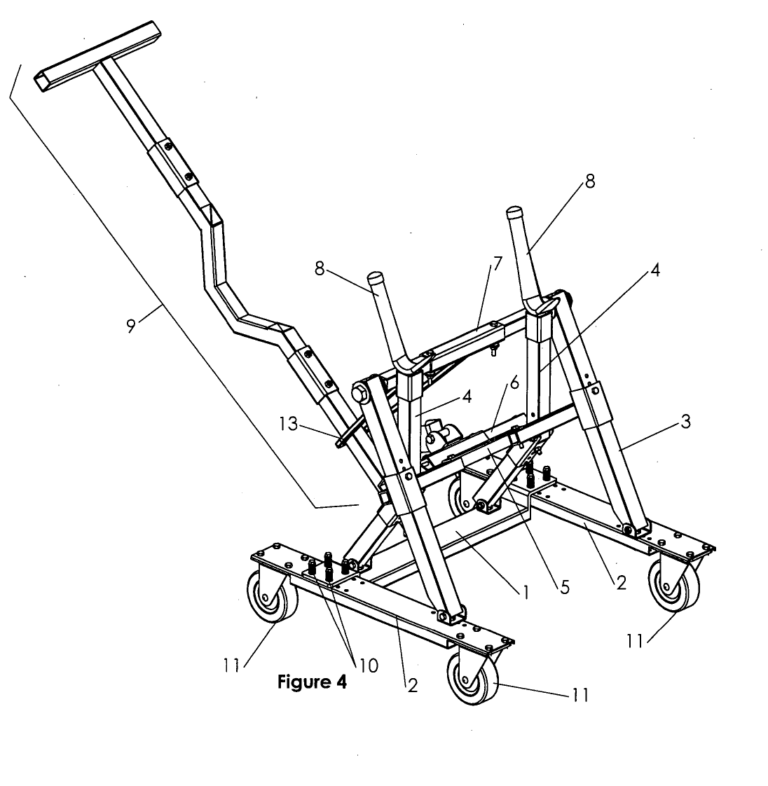

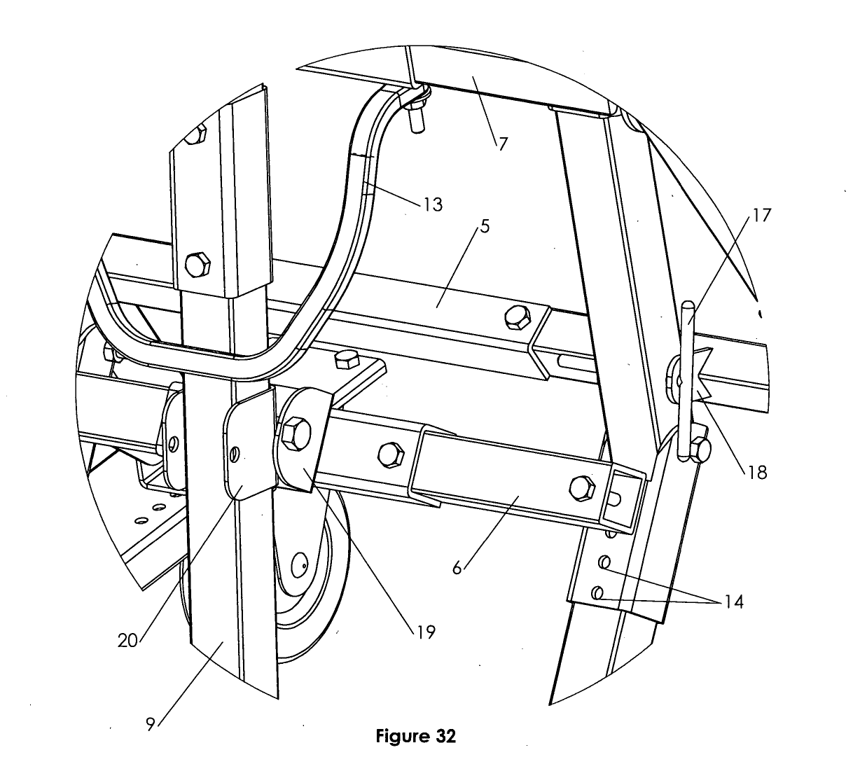

FIG. 4 is a front perspective view of the lifting device of the present invention with the handle 9 in a pulling position. In this position, the handle 9 is not locked to the second lateral member 6; instead, the top half of one of the second legs 4 is locked to the first lateral member 5 (see FIG. 32). This is the safety position for when the device is in storage on the lifting device. This position is also used for pulling or pushing the snowmobile on the lifting device because the handle is freely moveable. As shown in this figure, when the handle 9 is not locked in place against the second lateral member 6 (as shown in FIGS. 3 and 31), it is supported by a cord 13 that is attached to the third lateral member 7. The cord 13 prevents the handle 9 from falling to the ground.

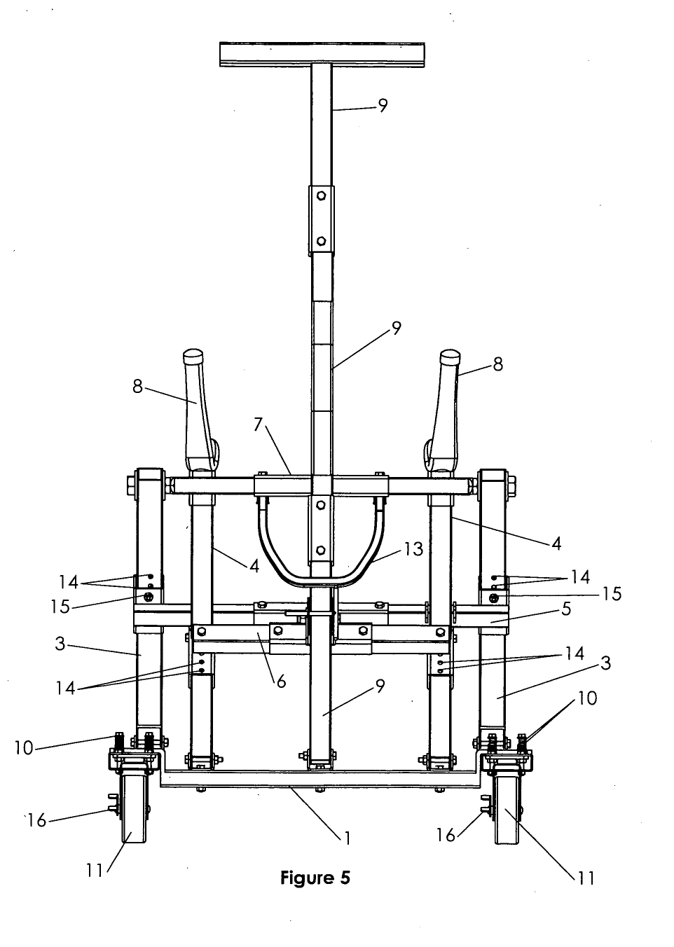

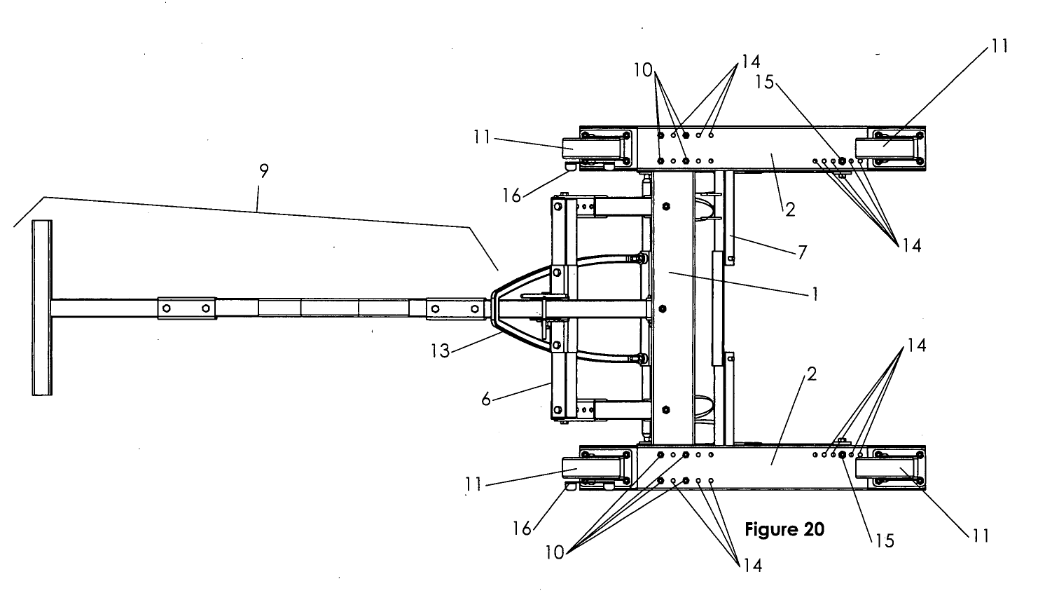

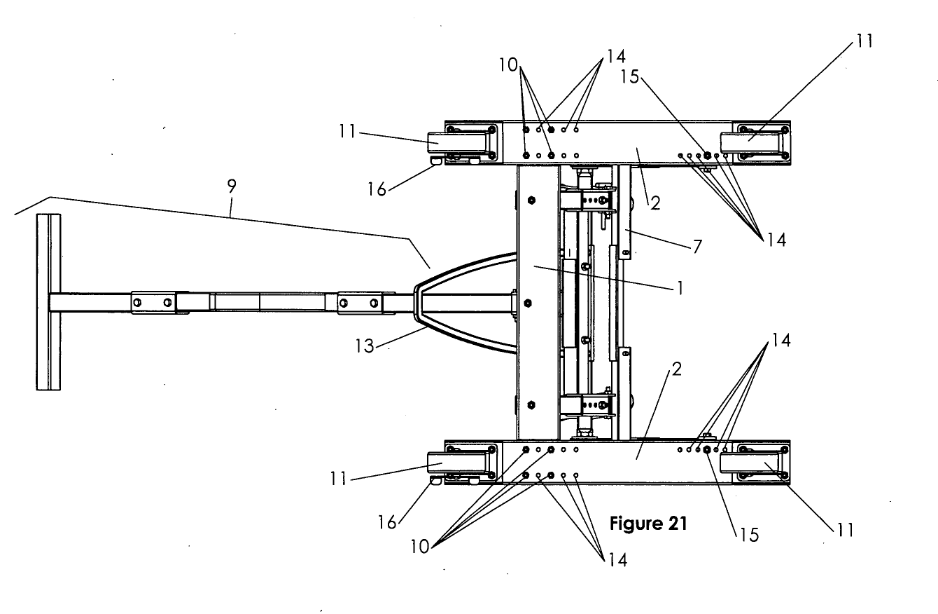

FIG. 5 is a front view of the lifting device of the present invention with the handle in an upright position. As shown in this figure, both the first legs 3 and the second legs 4 are optionally equipped for adjustability by including a series of apertures 14 that allow the first legs 3 and second legs 4 to be lengthened or shortened by moving a bolt 15 (bolt not shown for the second legs 4). In addition, the two front wheels 11 are optionally equipped with manual brakes 16 (shown in detail in FIG. 21A).

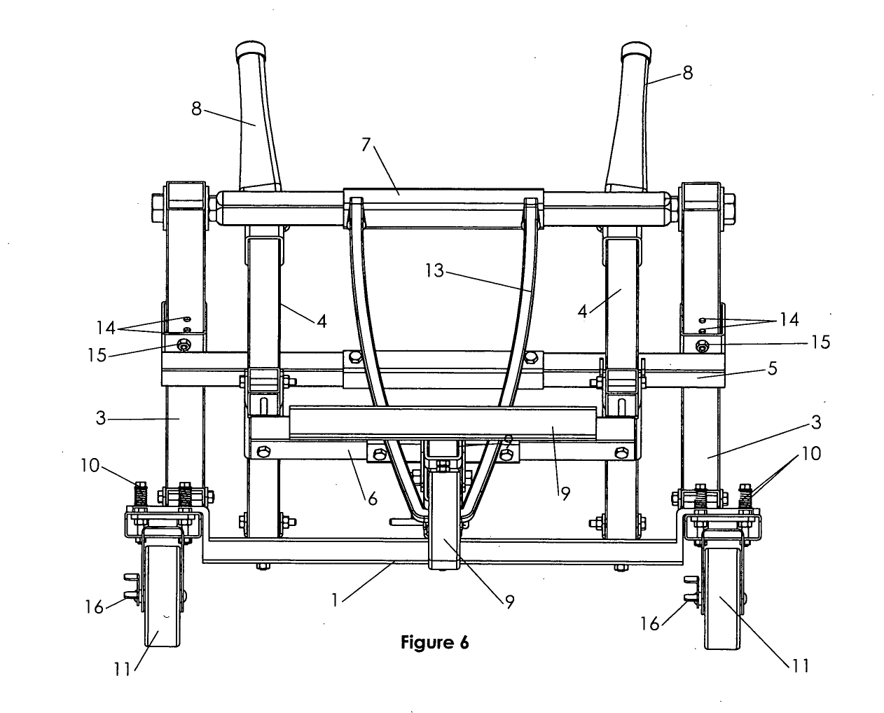

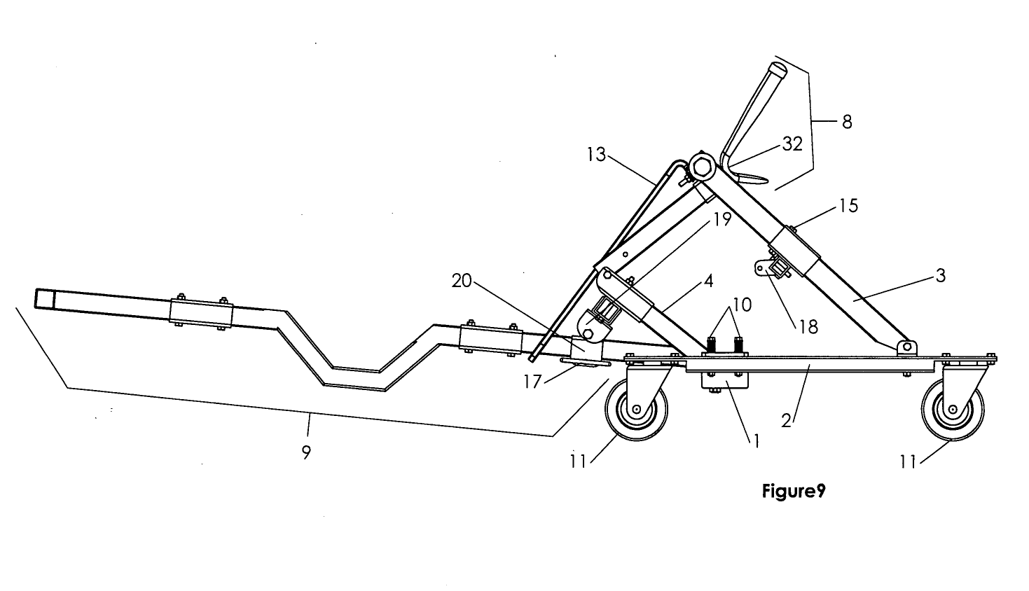

FIG. 6 is a front view of the lifting device of the present invention with the handle in an engage/disengage position. Note that in this figure, the second legs 4 are bent forward toward the handle (as shown in side view in FIG. 9).

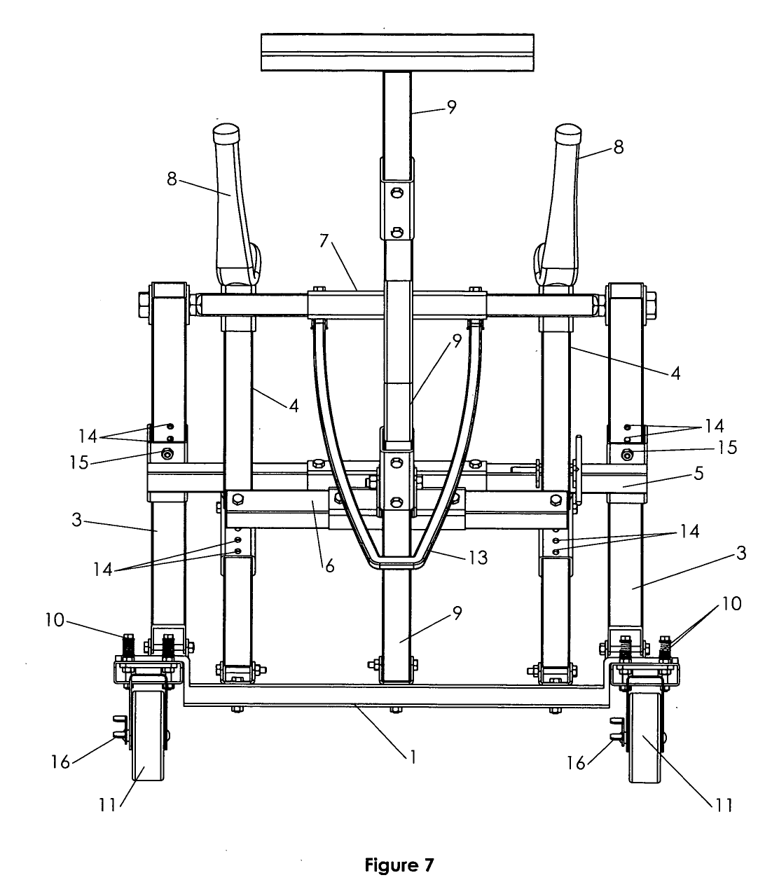

FIG. 7 is a front view of the lifting device of the present invention with the handle in a pulling position. In this figure, the second legs 4 are bent backward toward the first legs 3 (as shown in side view in FIG. 10).

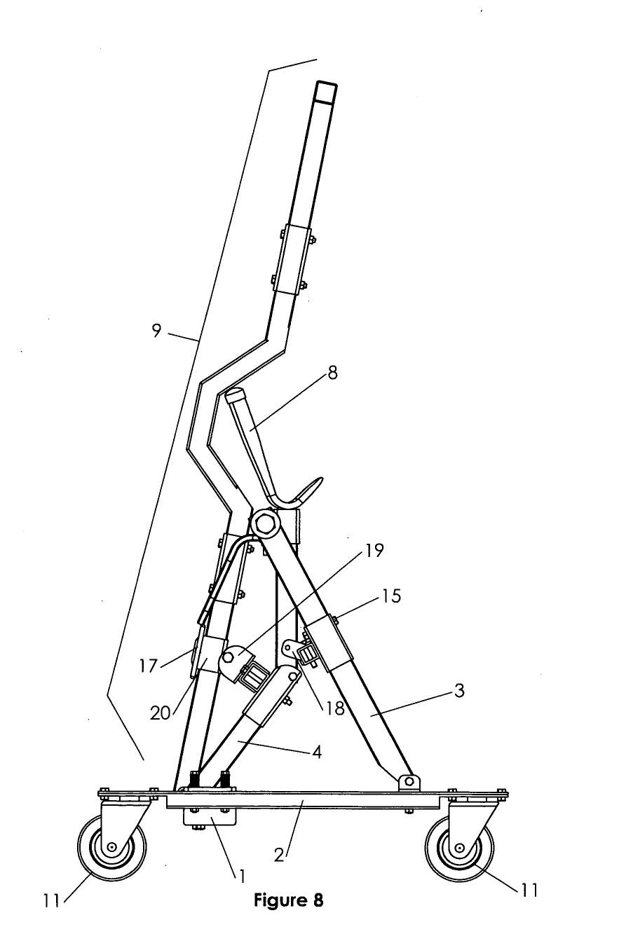

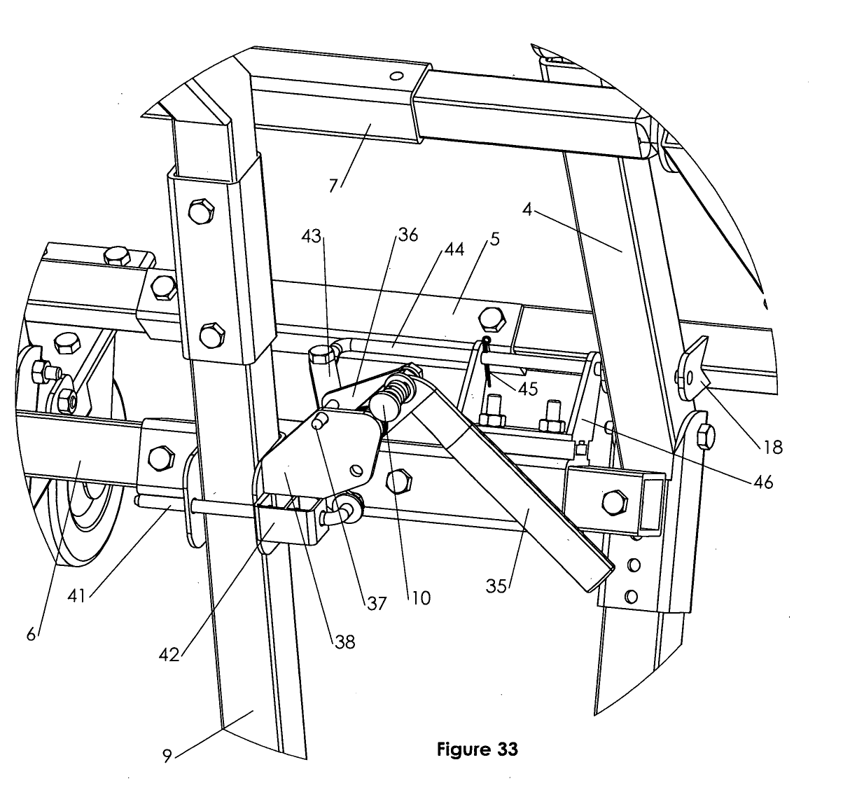

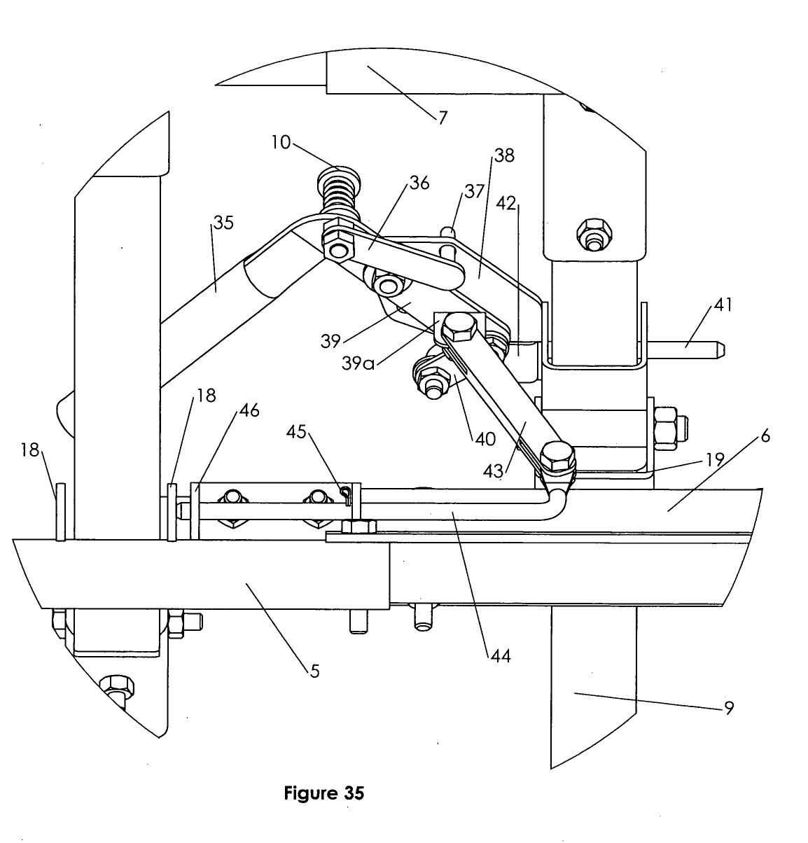

FIG. 8 is a side view of the lifting device of the present invention with the handle in an upright position. Note that in this figure, the first lateral member 5 is locked to the top half of the second leg 4 by a pin 17 that extends through an extension 18 of the first lateral member 5 and through an opening in the top half of the second leg 4. Although not shown in this figure, there is preferably another extension on the other side of the top half of the second leg 4 (see FIG. 35, which shows both extensions 18). This particular manual locking system is but one example of a locking system that could be utilized in connection with the present invention. Another automatic locking system is shown in FIGS. 33-38. The present invention is not limited to any particular locking system, and these two locking systems (manual and automatic) are shown by way of example.

FIG. 8 also illustrates the shape of the handle, which is preferably curved outward at its center to avoid contacting the front or rear railing 48 of a snowmobile (see FIG. 1). Additionally, as shown in this figure, the top half of the second leg 4 is preferably vertical or nearly vertical when the second legs 4 are bent inward (or toward the first legs). This particular configuration provides the greatest stability and ease of use.

FIG. 9 is a side view of the lifting device of the present invention with the handle in an engage/disengage position. In this figure, the second legs 4 are bent outward (away from the snowmobile), and the handle 9 is locked onto the second lateral arm 6. Note that in this embodiment, the second lateral member 6 comprises a first extension 19 and a second extension 20, which are pivotally connected. The pin 17 is inserted through a hole in the second extension 20 and passes across the front of the handle 9 and through another hole in the second extension 20 on the other side of the handle 9 (this is best shown in FIG. 31).

FIG. 10 is a side view of the lifting device of the present invention with the handle in a pulling position. In this figure, the second legs 4 are bent inward (toward the snowmobile), and the top half of one of the second legs 4 is locked onto the first lateral member 5 by a pin 17 that is inserted into the extension 18 of the first lateral member 5. As noted above, this is considered the “safety” position because it ensures that the lifting device will not collapse, although the device as designed should prevent collapse even without a safety latch because the force of gravity and the weight of the snowmobile will hold the second legs in an inwardly bent position. The second legs would have to bend outward in order for the lifting device to collapse (as shown in FIG. 3).

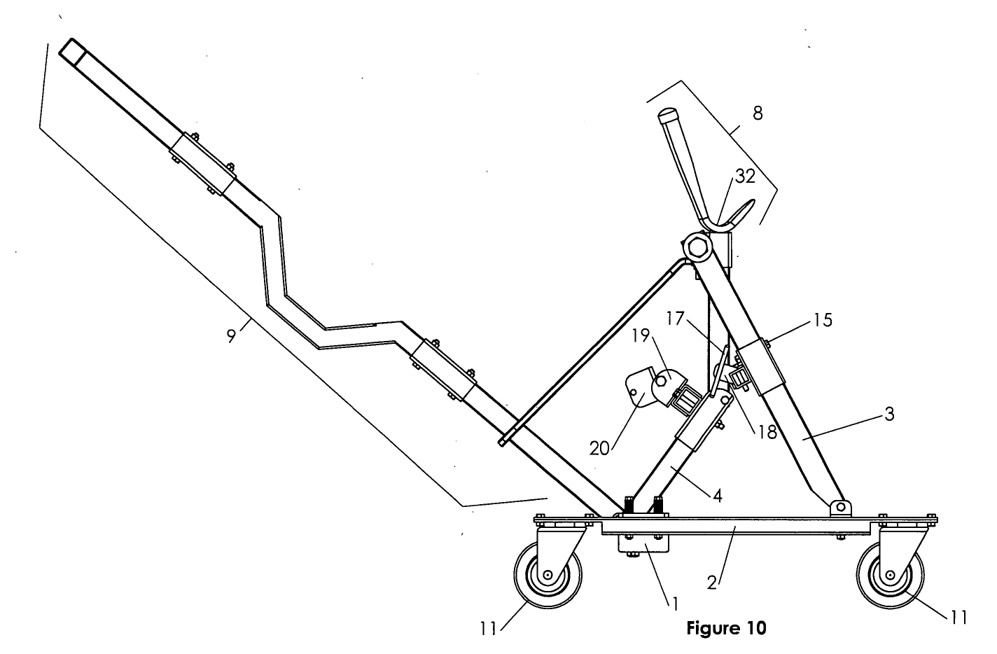

FIG. 11 is a side view of the present invention (as in FIG. 10) with an exploded view of the handle. As shown in this figure, the handle is optionally modular to allow its length and/or shape to be adjusted.

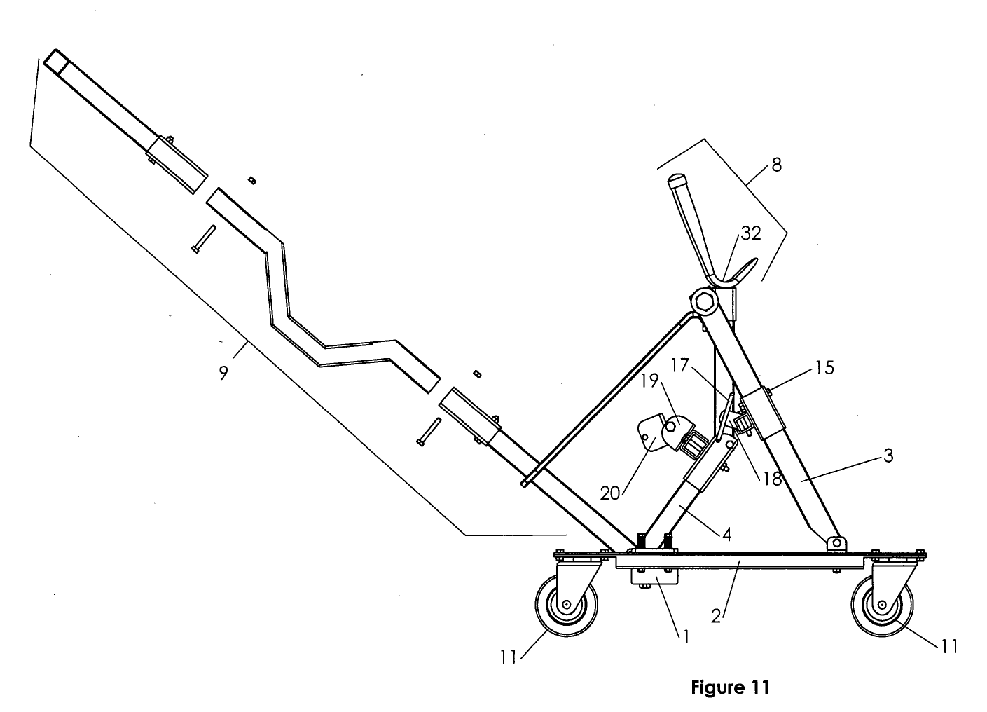

FIG. 12 is a perspective view of the spring bolts that attach the first cross-member to the side rails. The present invention is not limited to any particular method of attaching the cross-bar to the wheel support members, but the spring bolts provide desired flexibility for negotiating uneven surfaces, inclines or declines, and other obstacles.

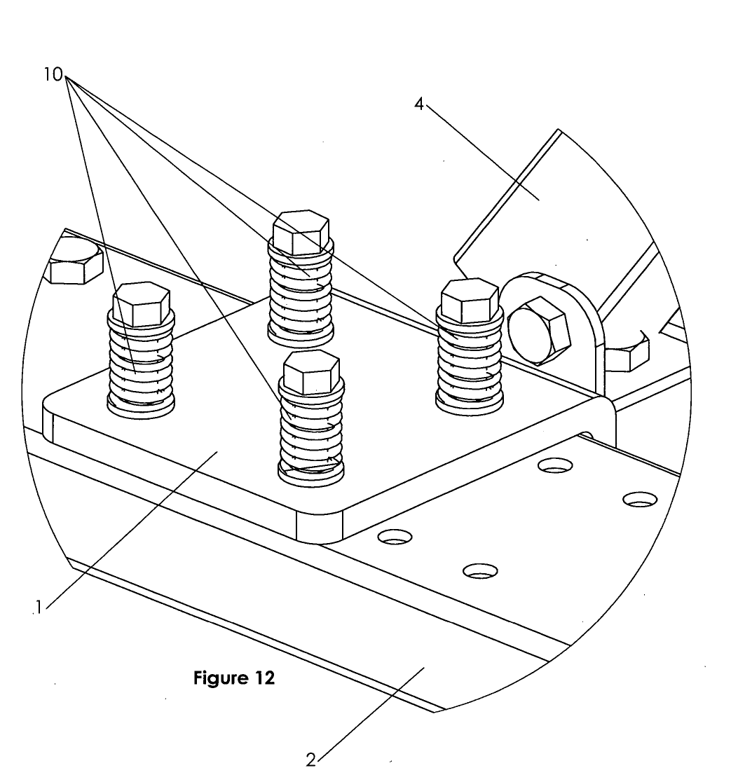

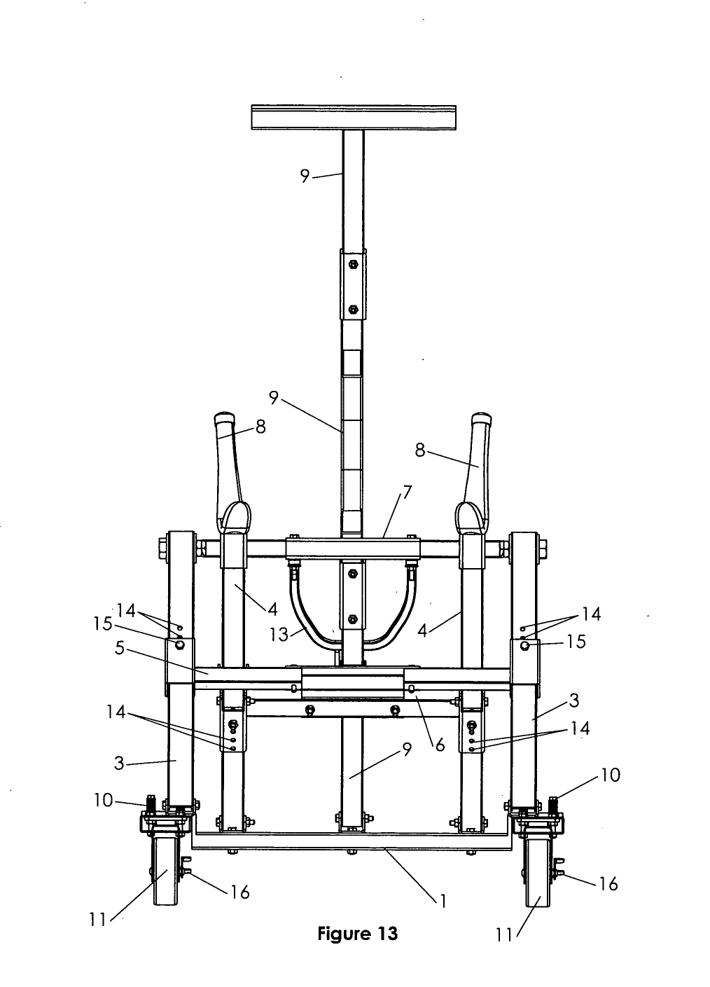

FIG. 13 is a rear view of the lifting device of the present invention with the handle in an upright position. In this figure, the lifting device is in the same position as in FIGS. 5 and 8. The width of the present invention can be optionally increased or decreased by adjusting the lengths of the cross-bar 1 and first 5, second 6 and third 7 lateral members. This figure shows the five pivot/swivel points of the present invention: two where the first legs attach to the wheel support members, two where the second legs attach to the cross-bar, and one where the handle attaches to the cross-bar.

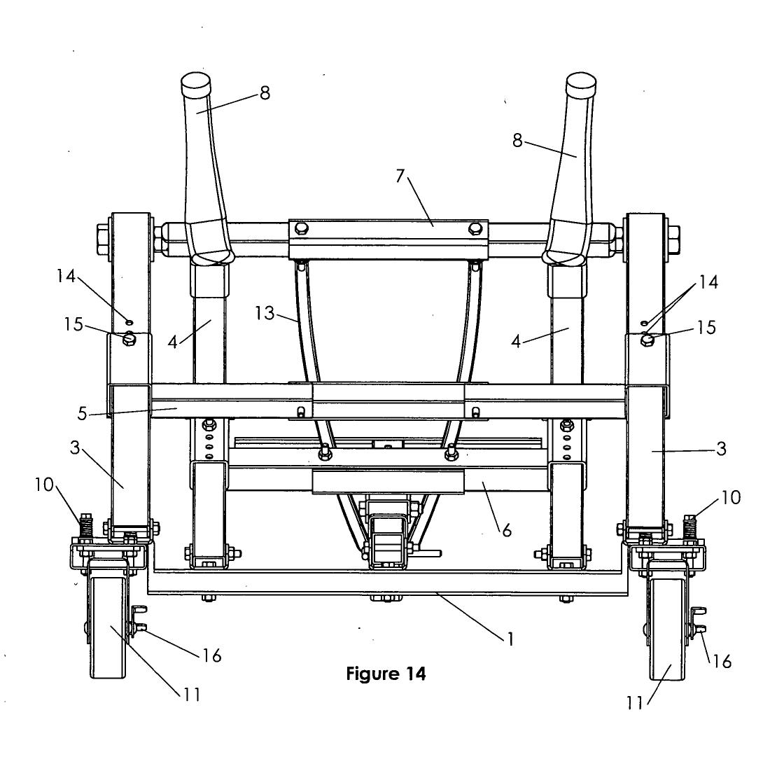

FIG. 14 is a rear view of the lifting device of the present invention with the handle in an engage/disengage position. In this figure, the lifting device is in the same position as in FIGS. 6 and 9.

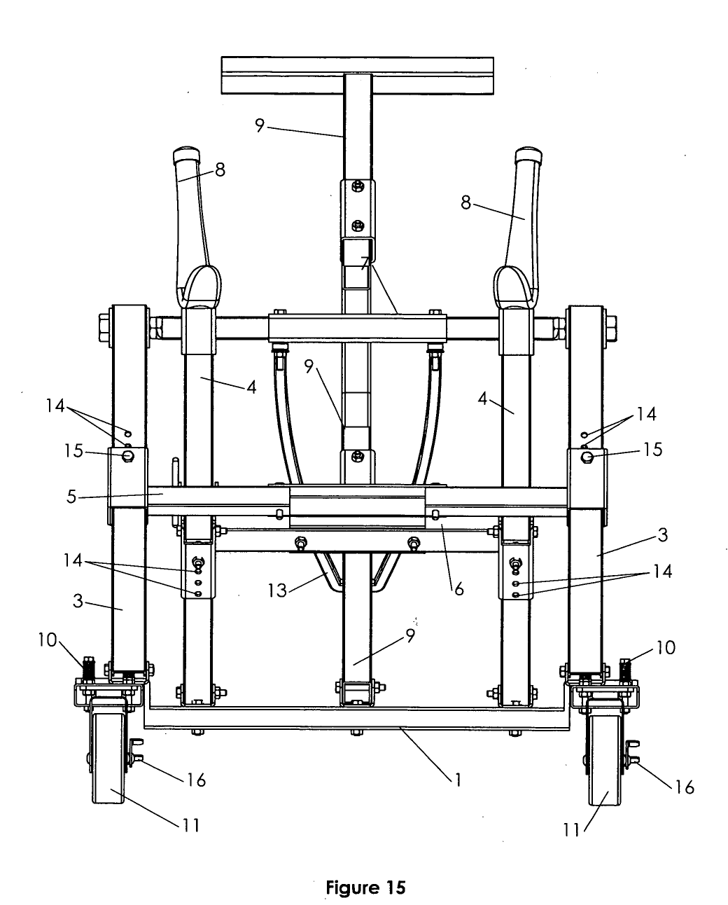

FIG. 15 is a rear view of the lifting device of the present invention with the handle in a pulling position. In this figure, the lifting device is in the same position as in FIGS. 7 and 10.

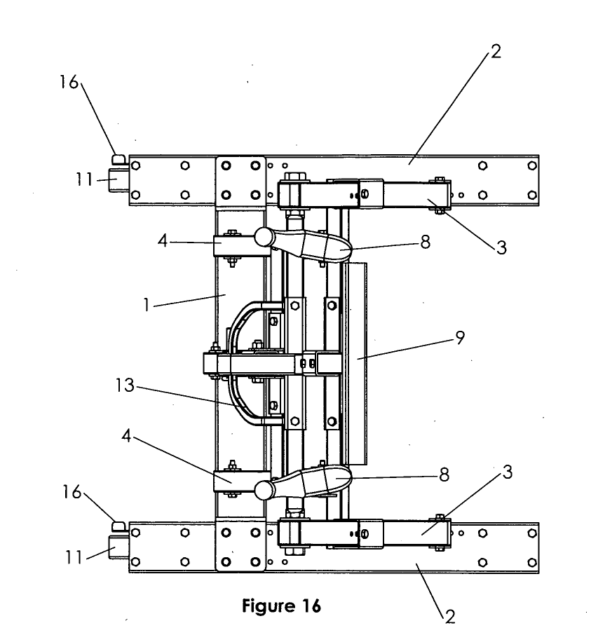

FIG. 16 is a top view of the lifting device of the present invention with the handle in an upright position. In this figure, the lifting device is in the same position as in FIGS. 5, 8 and 13.

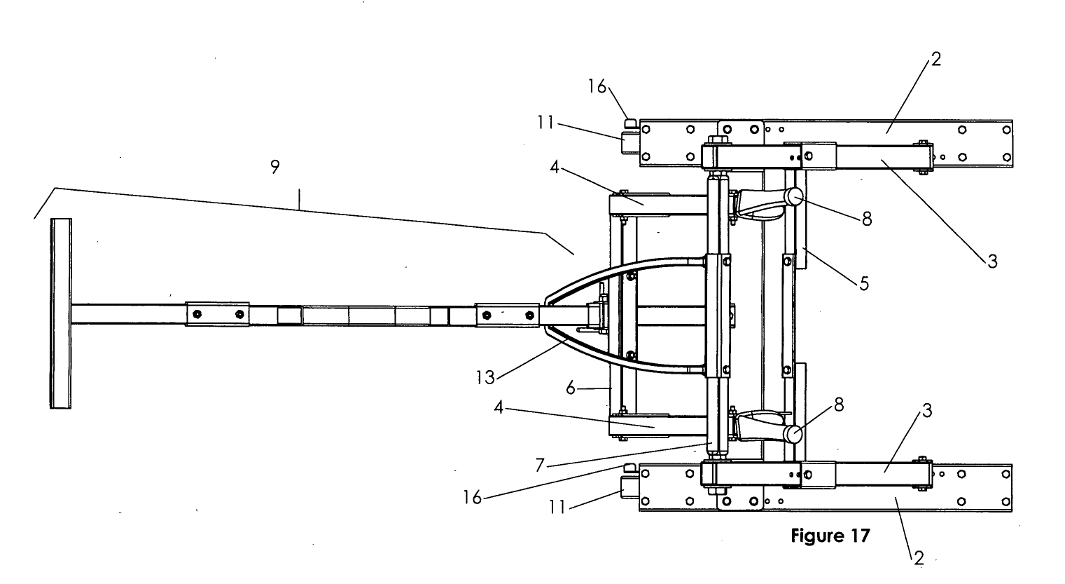

FIG. 17 is a top view of the lifting device of the present invention with the handle in an engage/disengage position. In this figure, the lifting device is in the same position as in FIGS. 6, 9 and 14.

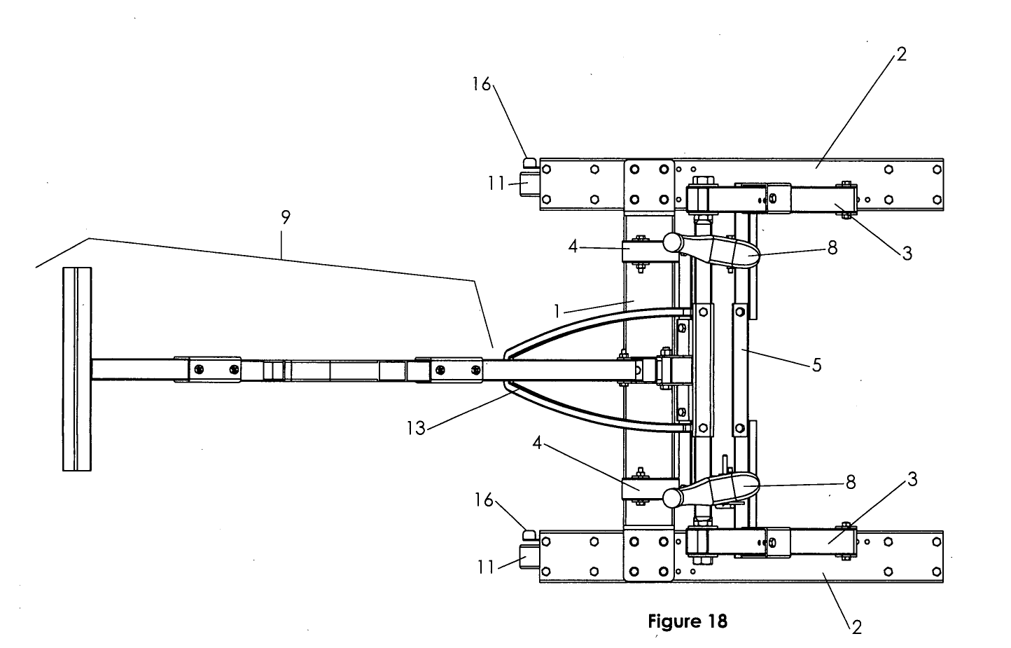

FIG. 18 is a top view of the lifting device of the present invention with the handle in a pulling position. In this figure, the lifting device is in the same position as in FIGS. 7, 10 and 15.

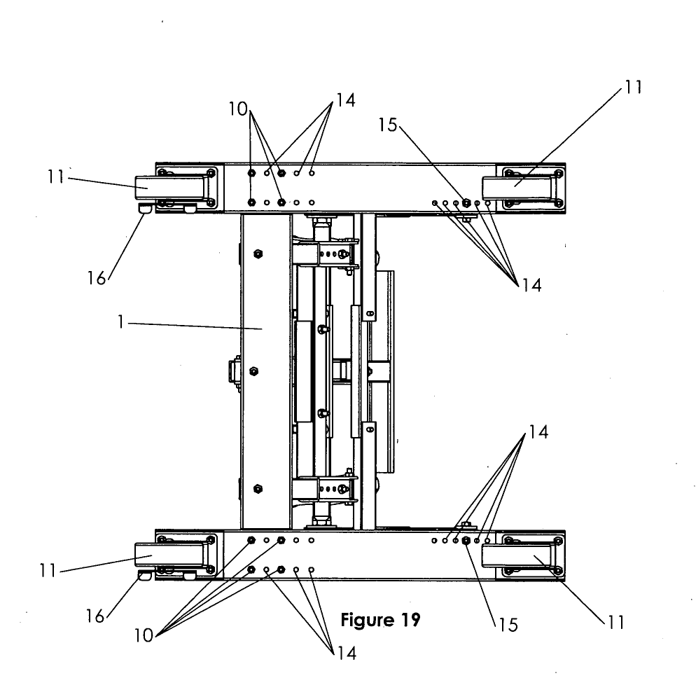

FIG. 19 is a bottom view of the lifting device of the present invention with the handle in an upright position. In this figure, the lifting device is in the same position as in FIGS. 5, 8, 13 and 16. This figure shows the optional apertures 14 (also shown in FIGS. 2-4 and 16-18) in the wheel support members 2 that allow for adjustability of the position of the cross-bar 1 on the wheel support members 2 and the first legs 3 on the wheel support members 2.

FIG. 20 is a bottom view of the lifting device of the present invention with the handle in an engage/disengage position. In this figure, the lifting device is in the same position as in FIGS. 6, 9, 14 and 17.

FIG. 21 is a bottom view of the lifting device of the present invention with the handle in a pulling position. In this figure, the lifting device is in the same position as in FIGS. 7, 10, 15 and 18.

As illustrated in FIGS. 21A and B, the front two wheels preferably comprise manual brakes. FIG. 21A is a front perspective view of the lifting device of the present invention showing the manual brakes on the two front wheels. FIG. 21B is a partial perspective view of one of the front wheels showing the manual brake.

FIG. 22 is a perspective view of a cradle arm extender 21. The cradle arm extender 21 can be used to extend the length of the top half of the second legs 4 when needed to fit a particular snowmobile or to utilize the device on the back end of a snowmobile. The cradle arm extender 21 is comprised of a tube, the top portion 22 of which has a greater outer diameter than the bottom portion 23. The bottom portion 23 of the cradle arm extender 21 fits inside the top end of the second leg 4, which is hollow. FIG. 22A is a perspective view of a cradle arm 8 separate from the lifting device. When used without a cradle arm extender 21, the bottom portion 25 of the cradle arm fits inside the top end of the second leg 4. When used with the cradle arm extender 21, the bottom portion 25 of the cradle arm 8 fits inside the top end of the cradle arm extender 21. The top portion 24 of the cradle arm 8 is the part of the lifting device that comes into direct contact with the snowmobile railing 48 (or bumper or similar feature on a different type of vehicle). So as to prevent scratching of the vehicle, the top portion 24 of the cradle arm is preferably coated with a protective coating such as plastic or rubber. The present invention is not limited to any particular shape or dimension of the cradle arm 8, as long as it is suitable for cradling or holding the railing 48 of a snowmobile or similar feature on another vehicle.

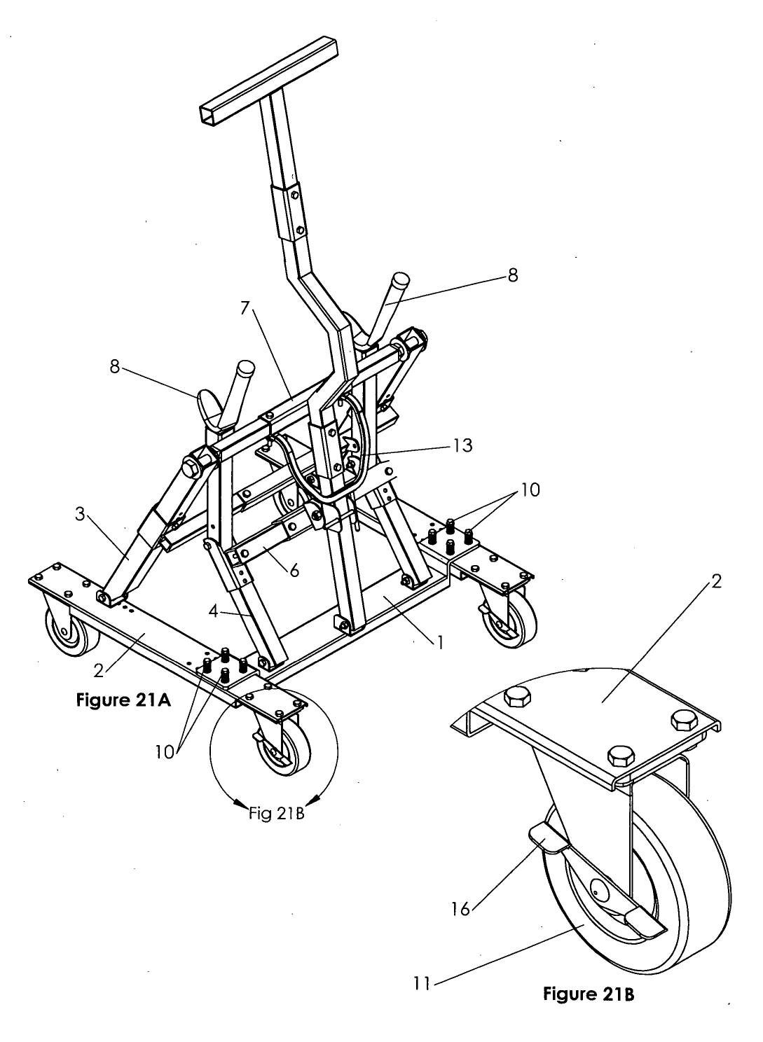

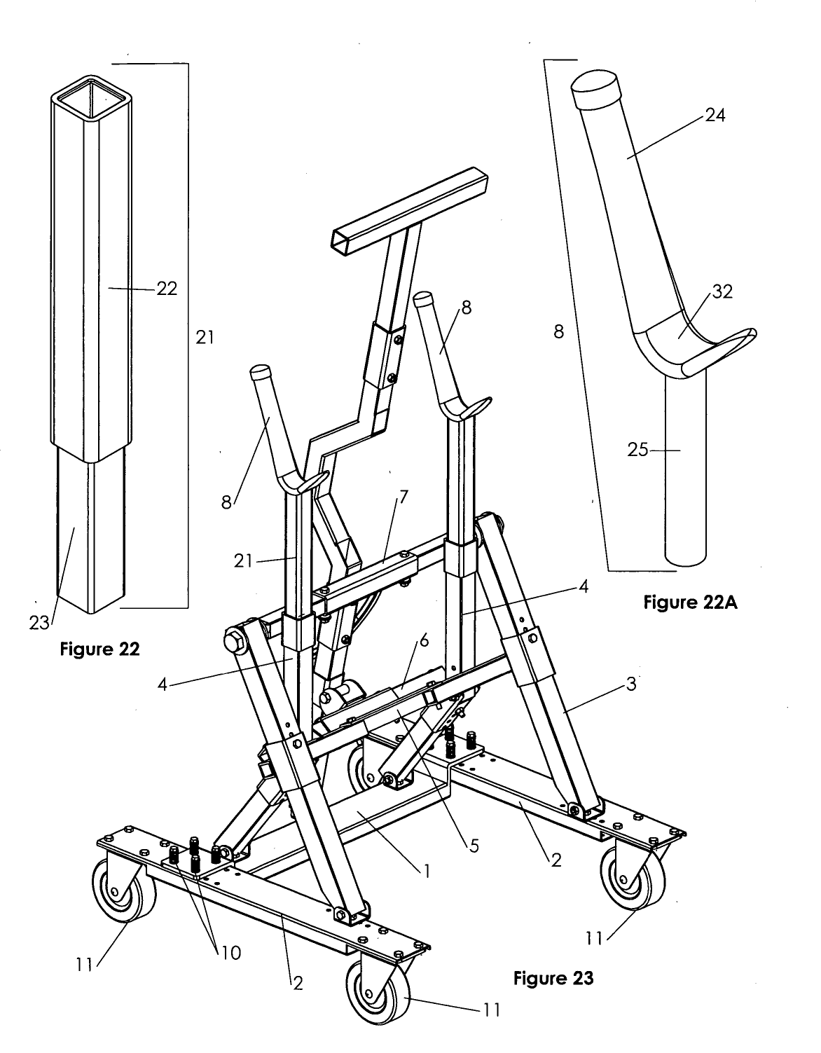

FIG. 23 is a front perspective view of the lifting device of the present invention with the cradle extensions 21 of FIG. 22. FIG. 24 is a perspective view of the lifting device of the present invention as shown in FIG. 23 on the rear of a snowmobile.

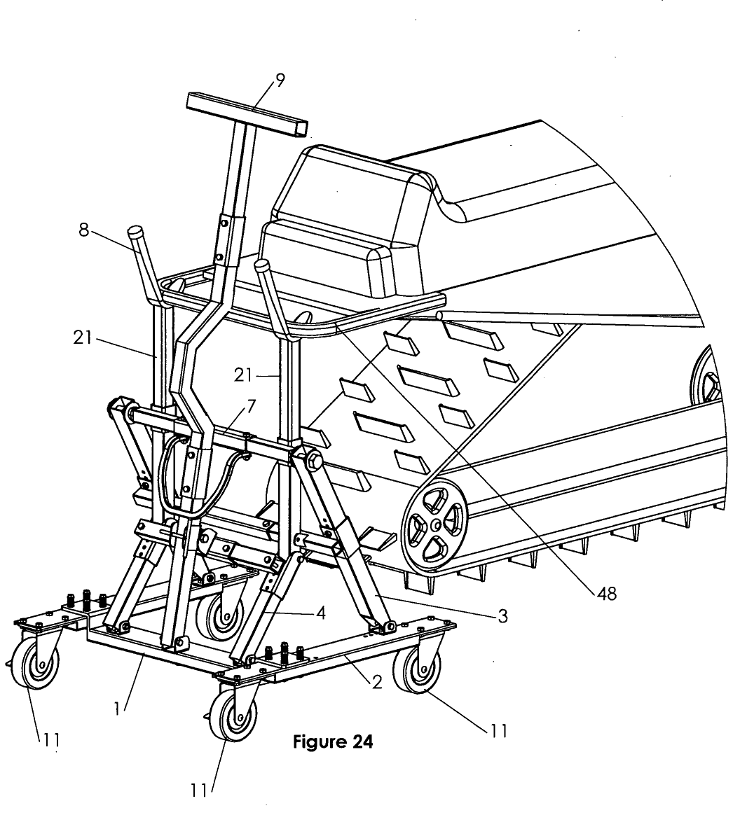

FIG. 25 is a perspective view of a first cradle arm adjustment member 26. The first cradle bar adjustment member comprises a first tube 27 and a second tube 28, the top portion of which has the same outer diameter as the first tube 27. The two tubes are joined by a bridge 28a. The bottom portion of the second tube 28 has a smaller outer diameter than the first tube 27 and the top portion of the second tube 28. The bottom portion of the second tube 28 fits inside the top of the second leg 4. The bottom portion 25 of the cradle arm 8 fits into the inside of the second tube 28 of the first cradle arm adjustment member 26. In this manner, the distance between the two cradle arms 8 can be increased or decreased through the use of the first cradle arm adjustment members 26.

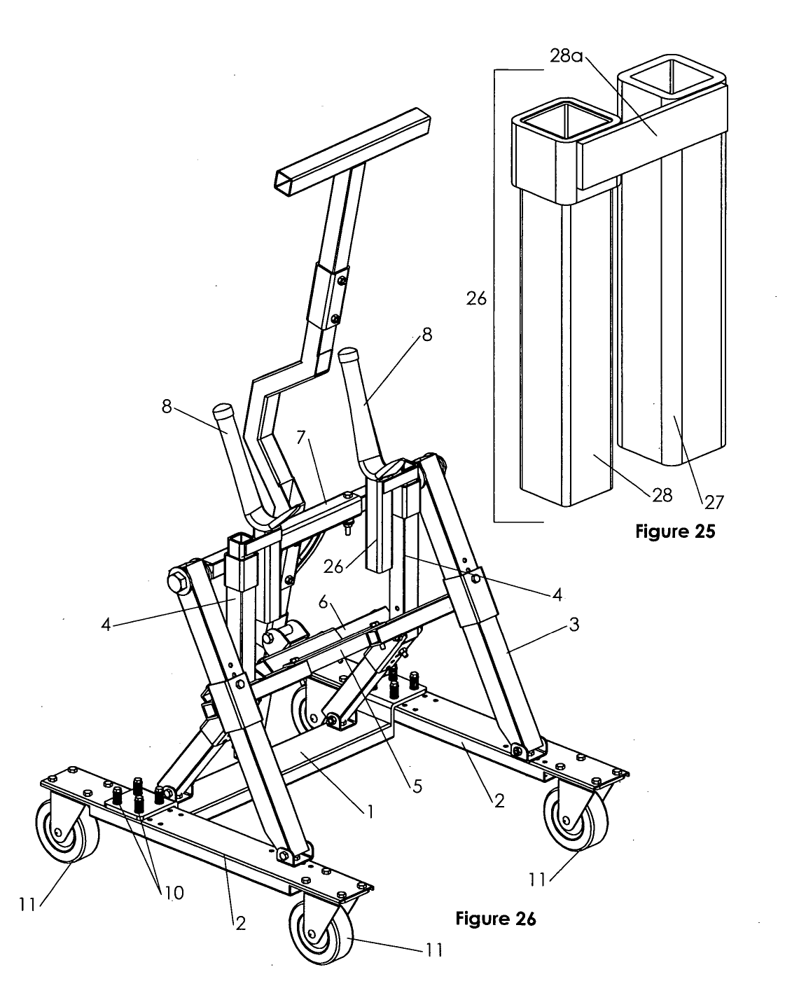

FIG. 26 is a rear perspective view of the lifting device of the present invention with the first cradle arm adjustment members 26 in a first orientation. In this orientation, the cradle arms 8 are closer together than they would be without the first cradle arm adjustment members 26. In a second orientation (not shown), the first cradle arm adjustment members 26 are situated so that the first tube 27 is on the outside of the second tube 28, which would cause the cradle arms 8 to be further apart than they would be without the first cradle arm adjustment members 26.

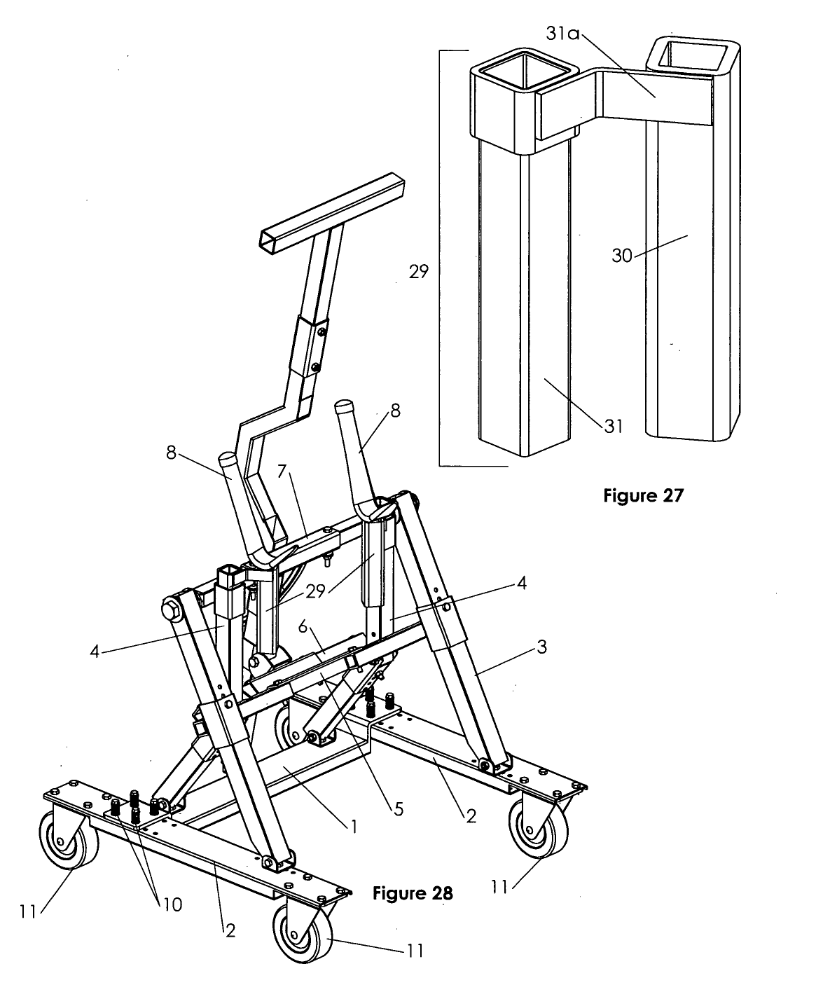

FIG. 27 is a perspective view of a second cradle arm adjustment member 29. The second cradle arm adjustment member 29 is the same as the first cradle arm adjustment member 26, except that the first and second tubes 30, 31 are oriented diagonally with respect to each other. FIG. 28 is a rear perspective view of the lifting device of the present invention with the second cradle arm adjustment members 29 in a first orientation. In this orientation, the cradle arms 8 are closer together and further from the third lateral member 7 than they would be without the second cradle arm adjustment members 29. In a second orientation (not shown), the second cradle arm adjustment members 29 are situated so that the cradle arms 8 are further apart and further from the third lateral member 7 than they would be without the second cradle arm adjustment members 29. The purpose of providing the adjustability afforded by the first and second cradle arm adjustment members is to allow the device to be used with various makes and models of snowmobiles or similar types of vehicles.

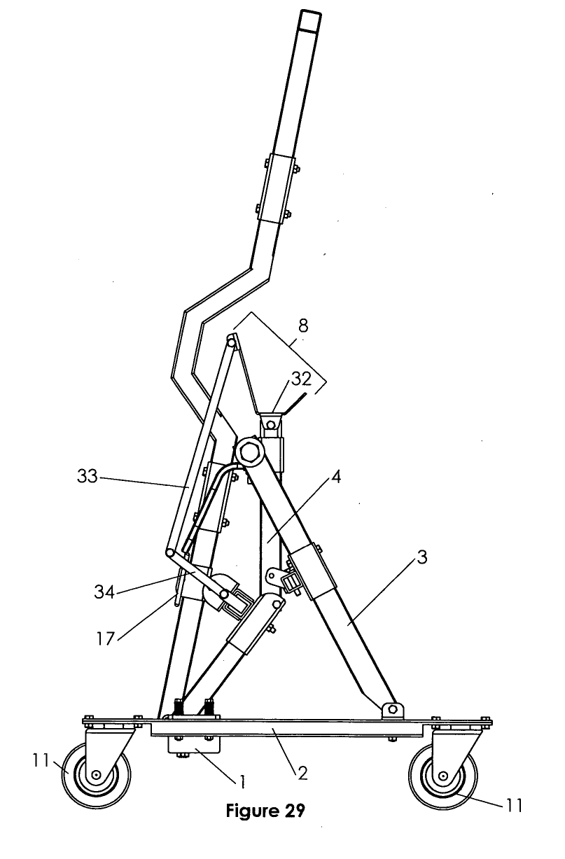

FIG. 29 is a side view of the lifting device of the present invention with an alternate cradle mechanism that maintains the floor of the cradle arm parallel with the ground. In this figure, the handle is in an upright position. The cradle mechanism comprises a cradle arm 8 with a floor 32. The cradle arm is pivotally attached at its uppermost end to a first connecting arm 33, which in turn is pivotally attached at its other end to a second connecting arm 34. The second connecting arm 34 is pivotally attached to the second lateral member 6 at the end opposite that which attaches to the first connecting arm 33:

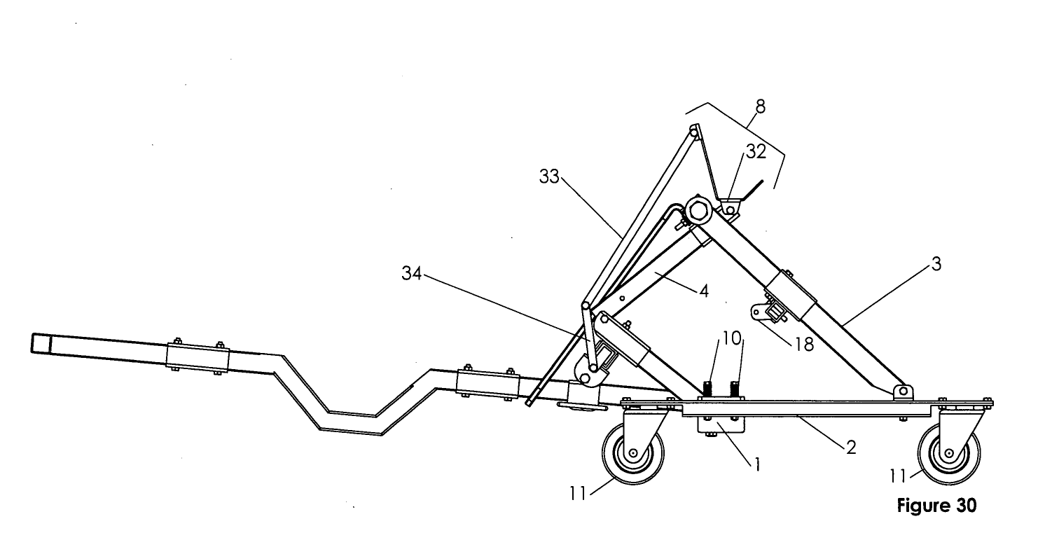

FIG. 30 is a side view of the lifting device of the present invention with the same alternate cradle mechanism shown in FIG. 29, except that the handle is in an engage/disengage position. In this position, the floor 32 of the cradle arm 8 is still parallel to the ground. By comparison, in FIG. 9, the floor 32 of the cradle arm 8 is not parallel with the ground. The alternate cradle mechanism shown in FIGS. 29 and 30 can be used where it is important to maintain a constant angle between the floor of the cradle arm 8 and the ground.

FIG. 31 is a front perspective view of the manual locking system of the present invention with the handle 9 locked onto the second lateral member 6. In this configuration, the pin 17 runs through the second extension 20 of the second lateral member 6. In this figure, the second legs 4 are bent away from the handle (or toward the snowmobile); therefore, this figure shows the position of the lifting device right before disengaging the lifting device from the snowmobile or immediately after lifting the snowmobile onto the lifting device (before moving the pin over to the position shown in FIG. 32).

FIG. 32 is a front perspective view of the same manual locking system shown in FIG. 31, except that the first lateral member 5 is locked onto the top half of one of the second legs 4. In this configuration, the pin 17 runs through the extension 18 of the first lateral member 5. This figure shows the position of the lifting device in a storage position.

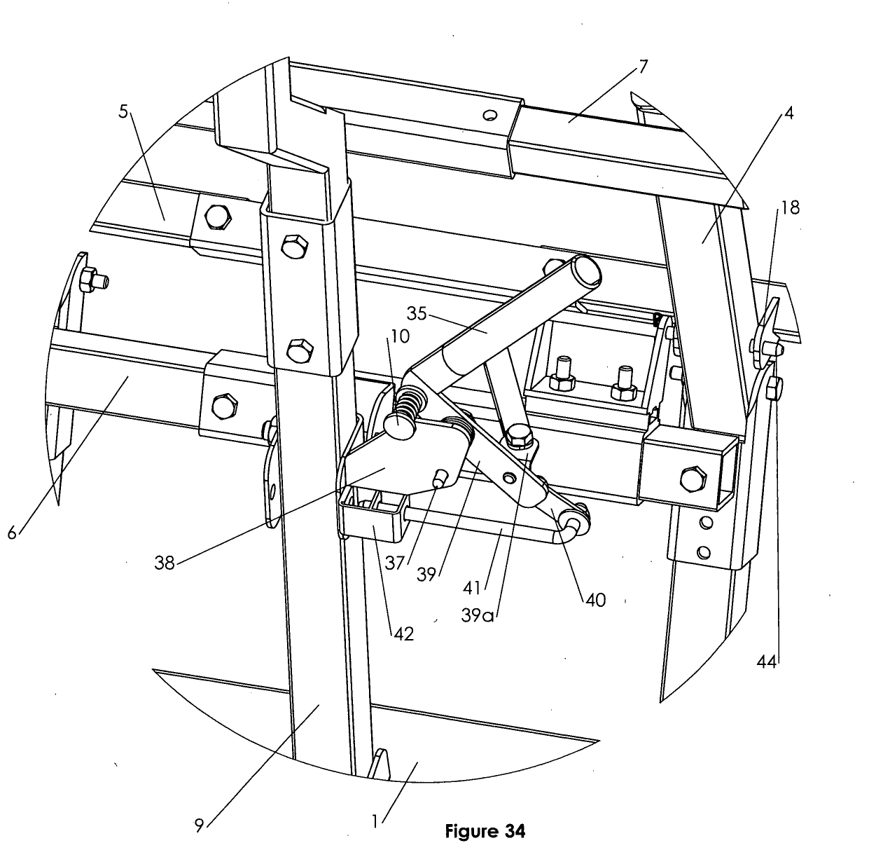

FIGS. 33-38 show an alternative locking system. FIG. 33 is a front perspective view of the automatic locking system of the present invention with the handle 9 locked onto the second lateral member 6. The automatic locking system comprises a lever 35, a spring bolt 10 that connects one end of the lever 35 to a first connecting bar 36, and a peg 37 that is attached to one end of the first connecting bar 36. The peg 37 passes through a hole in the connecting plate 38. When the spring bolt 10 is compressed, the peg 37 can be moved from a first position (shown in FIG. 33) to a second position (shown in FIG. 34). The connecting plate 38 is attached to the second extension 20 of the second lateral member 6.

FIG. 34 is a front perspective view of the automatic locking system of the present invention with the first lateral member 5 locked onto the top half of one of the second legs 4. In this figure, the peg 37 is in a different position than that shown in FIG. 33 (i.e., it is inserted into a different hole in the connecting plate 38). This figure shows the second connecting bar 39, which is attached to the lever 35 and pivotally attached to the connecting plate 38. The second connecting bar 39 is pivotally attached to a third connecting bar 40, which in turn is pivotally attached to a first rod 41, which passes through a guide box 42 and through the holes in the second extension 20 of the second lateral member 6.

FIG. 35 is a rear perspective view of the automatic locking system in the same position shown in FIG. 33. As shown in this figure, the second connecting bar 39 is pivotally attached to the third connecting bar 40, which is pivotally attached to the first rod 41. The second connecting bar 39 is also pivotally attached to an L-shaped flange 39a, which in turn is pivotally attached to the fourth connecting bar 43. The fourth connecting bar 43 is attached at its opposite end to a second rod 44. The second rod 44 passes through an upper housing 46, two extensions 18 on the first lateral member 5, and the top half of one of the second legs 4. A spring clip 45 or similar piece can be used to prevent the second rod 44 from moving too far in the lateral direction.

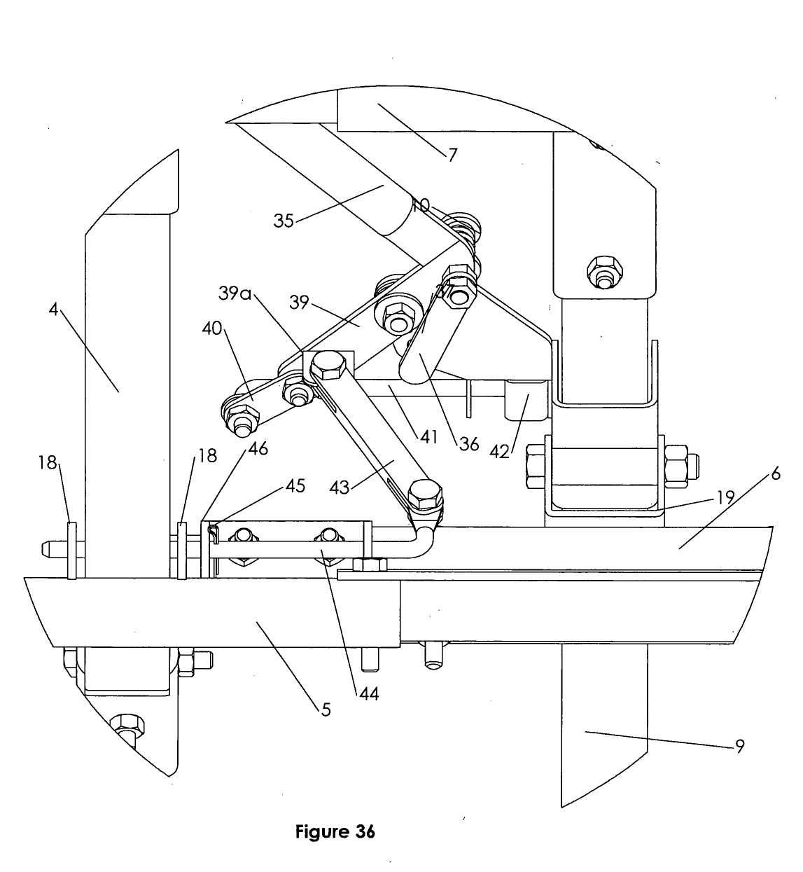

FIG. 36 is a rear perspective view of the automatic locking system of the present invention in the same position shown in FIG. 34.

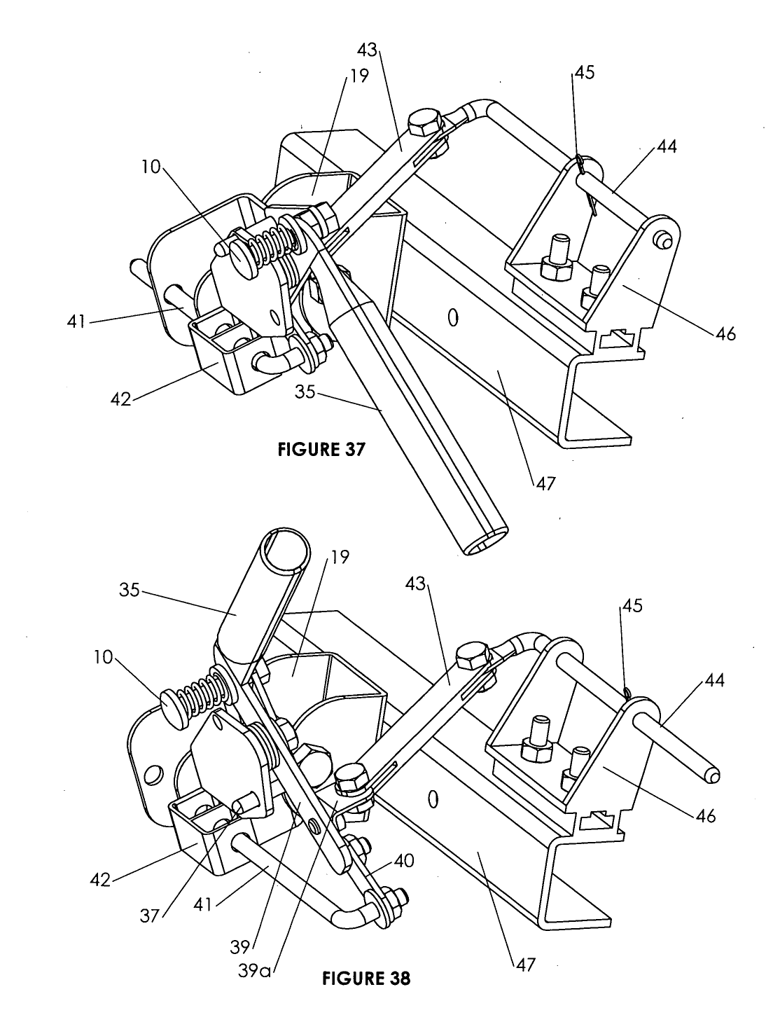

FIG. 37 is a side perspective view of the automatic locking system of the present invention separate from the lifting device. In this figure, the locking system is in the position it would be in if the handle were locked onto the second lateral member (i.e., the engage/disengage position). This figure illustrates the ease with which the automatic locking system can be installed onto or removed from the lifting device. The system includes a lower housing 47 that can be bolted or otherwise attached to the front of the second lateral member 6. Attached to the housing 47 are the first and second extensions 19, 20 of the second lateral member 6 (not shown).

FIG. 38 is a side perspective view of the automatic locking system of the present invention separate from the lifting device. In this figure, the locking system is in the position it would be in if the device were locked for storage (i.e., with the top half of one of the second legs locked onto the first lateral member).

Although the preferred embodiment of the present invention has been shown and described, it will be apparent to those skilled in the art that many changes and modifications may be made without departing from the invention in its broader aspects. The appended claims are therefore intended to cover all such changes and modifications as fall within the true spirit and scope of the invention.

I claim:

1. A snowmobile lifting device comprising a cross-bar, two wheel support members, two first legs, two second legs, a first lateral member, a second lateral member, a third lateral member, two cradle arms, and a handle, wherein each end of the cross-bar is attached to a wheel support member, wherein each of the two first legs is connected at one end to a wheel support member and at the other end to the third lateral member, wherein each of the two second legs is connected at one end to the cross-bar and at the other end to the third lateral member, wherein the first lateral member joins the two first legs, wherein the second lateral member joins the two second legs, wherein the two second legs pivot inward or outward proximate to the point at which the second lateral member joins the two second legs, and wherein the handle is pivotally attached to the center of the cross-bar.

2. The snowmobile lifting device of claim 1, wherein the two cradle arms are positioned at the top of each of the two second legs.

3. The snowmobile lifting device of claim 1, wherein the top of the second legs are hollow, and wherein the cradle arms comprise a bottom portion that fits inside the top of the second legs.

4. The snowmobile lifting device of claim 1, wherein the cross-bar is attached to the two wheel support members by a plurality of spring bolts.

5. The snowmobile lifting device of claim 1, further comprising four caster wheels, wherein two caster wheels are attached to the bottom of each of the wheel support members.

6. The snowmobile lifting device of claim 5, wherein at least two of the wheels comprise manual brakes.

7. The snowmobile lifting device of claim 1, wherein one end of each of the two first legs is pivotally attached to one of the wheel support members.

8. The snowmobile lifting device of claim 1, wherein the two first legs swivel at the point at which they attach to the wheel support members.

9. The snowmobile lifting device of claim 1, wherein one end of each of the two first legs is pivotally attached to the third lateral member.

10. The snowmobile lifting device of claim 1, wherein one end of each of the two second legs is pivotally attached to the cross-bar.

11. The snowmobile lifting device of claim 1, wherein the two second legs swivel at the point at which they attach to the cross-bar.

12. The snowmobile lifting device of claim 1, wherein the handle swivels at the point at which it attaches to the cross-bar.

13. The snowmobile lifting device of claim 1, further comprising a means for releasably locking the handle to the second lateral member.

14. The snowmobile lifting device of claim 13, wherein the second lateral member comprises a first extension and a second extension, and wherein the means for releasably locking the handle to the second lateral member comprises a pin that is inserted through a hole in the second extension and passes across the front of the handle and through another hole in the second extension on the other side of the handle.

15. The snowmobile lifting device of claim 13, further comprising a cord that prevents the handle from falling to the ground when it is not locked to the second lateral member.

16. The snowmobile lifting device of claim 1, further comprising a means for releasably locking the top half of one of the second legs to the first lateral member.

17. The snowmobile lifting device of claim 16, wherein the first lateral member comprises an extension, and wherein the means for releasably locking the top half of one of the second legs to the first lateral member comprises a pin that is inserted through a hole in the extension and a hole in the top half of the second leg.

18. The snowmobile lifting device of claim 1, wherein the length of the first legs is adjustable.

19. The snowmobile lifting device of claim 1, wherein the length of the second legs is adjustable.

20. The snowmobile lifting device of claim 1, wherein the handle is curved outward at its center.

21. The snowmobile lifting device of claim 1, wherein the handle is modular to allow its length and/or shape to be adjusted.

22. The snowmobile lifting device of claim 1, wherein the width of the device can be increased or decreased by adjusting the lengths of the cross-member and the first, second and third lateral members.

23. The snowmobile lifting device of claim 1, wherein the point at which the cross-bar attaches to each wheel support member is adjustable.

24. The snowmobile lifting device of claim 1, wherein the point at which each of the two first legs attaches to the wheel support member is adjustable.

25. The snowmobile lifting device of claim 1, further comprising two cradle arm extenders that fit into the top of the second legs, and wherein the cradle arms fit into the top of the cradle arm extenders.

26. The snowmobile lifting device of claim 1, wherein the cradle arms each comprises a top portion, and wherein the top portion is coated with a protective coating.

27. The snowmobile lifting device of claim 26, wherein the protective coating is plastic or rubber.

28. The snowmobile lifting device of claim 1, further comprising two cradle arm adjustment members, wherein each cradle arm adjustment member comprises two tube-like members joined by a bridge, wherein one of the tube-like members fits into the top of one of the second legs, and wherein one of the cradle arms fits into the top of the other tube-like member.

29. The snowmobile lifting device of claim 1, wherein the cradle arms comprise a floor, further comprising a cradle mechanism that maintains the floor of the cradle arm parallel with the ground.

30. The snowmobile lifting device of claim 29, wherein the cradle mechanism comprises a first connecting arm and a second connecting arm, wherein the first connecting arm is pivotally attached at one end to the cradle arm and pivotally attached at the other end to one end of the second connecting arm, and wherein the second connecting arm is pivotally attached at its other end to the second lateral member.

31. The snowmobile lifting device of claim 1, further comprising a means for releasably locking the handle to the second lateral member and a means for releasably locking the top half of one of the second legs to the first lateral member, wherein the means for releasably locking the handle to the second lateral member and the means for releasably locking the top half of one of the second legs to the first lateral member comprises an automatic locking system, wherein the automatic locking system comprises a lever, a spring bolt that connects one end of the lever to a first connecting bar, a peg that is attached to the other end of the first connecting bar, and a connecting plate, wherein the second lateral member comprises a first extension and a second extension, wherein the connecting plate is attached to the second extension, wherein the connecting plate comprises a first hole and a second hole, and wherein when the spring bolt is compressed, the peg can be moved from a first position in which it is inserted into the first hole in the connecting plate to a second position in which it is inserted into the second hole in the connecting plate.

32. The snowmobile lifting device of claim 31, wherein the automatic locking system further comprises a second connecting bar, a third connecting bar, and a guide box, wherein the second connecting bar is attached to the lever and pivotally attached to the connecting plate and pivotally attached to the third connecting bar, wherein the third connecting bar is pivotally attached to a first rod, wherein the guide box is attached to the second extension, and wherein the first rod passes through the guide box and through holes in the second extension when the peg is inserted into the second hole in the connecting plate.

33. The snowmobile lifting device of claim 32, wherein the first lateral member comprises an extension, wherein the automatic locking system comprises an upper housing and a lower housing, wherein the second connecting bar is pivotally attached to an L-shaped flange, wherein the L-shaped flange is pivotally attached to a fourth connecting bar, wherein the fourth connecting bar is attached at its other end to a second rod, and wherein the second rod passes through holes in the upper housing, the extension of the first lateral member and the top half of one of the second legs when the peg is inserted into the first hole in the connecting plate.
